(19) United States
(12) Patent Application Publication
(10) Pub. No.: US 2024/0265204 A1
(43) Pub. Date: Aug. 8, 2024

(54) GENERATING USER-SPECIFIC SYNTHETIC CONTENT UTILIZING MACHINE LEARNING WITH USER CREATED CONTENT ITEMS

(71) Applicant: Dropbox, Inc., San Francisco, CA (US)

(72) Inventors: Christopher Meeks, Austin, TX (US); Christopher T Lesniewski-Laas, Oakland, CA (US)

(21) Appl. No.: 18/164,373

(22) Filed: Feb. 3, 2023

(51) Int. Cl. G06F 40/279; G06T 11/60

(52) U.S. Cl. CPC G06F 40/279; G06T 11/60

(57) ABSTRACT

This disclosure describes embodiments of systems, methods, and non-transitory computer readable storage media that can utilize artificial intelligence to generate user-specific content based on content collections associated with a user account. Indeed, in one or more implementations, the disclosed systems utilize machine learning to intelligently generate new, custom content items that emulate user-specific content attributes based on content collections associated with a user account. In some instances, the disclosed systems utilize a content generation model that is trained to generate new content items in response to user requests (e.g., requests that describe one or more features). Furthermore, the disclosed systems can fine tune or modify parameters of the content generation model with content items from the content collections associated with the user account to create a custom content generation model that synthesizes at least one attribute of the user account's content items within generated, new content items.

### BACKGROUND

In recent years, online or “cloud” storage systems have increasingly stored and managed electronic media generated via client devices. For example, some existing document hosting systems provide tools for users to create, modify, delete, and share electronic media within a document or file synchronizing environment that is accessible through mobile applications or other software applications. By providing web-based (or app-based) tools for such document and file synchronization, existing document hosting systems often provide tools for users to retrieve, view, and modify a number of electronic media that are synchronized between multiple client devices of a user.

Despite such existing document hosting systems providing tools to retrieve, view, and modify a number of electronic media, these existing systems face a number of technical shortcomings in content creation. For example, many existing document hosting systems provide user interfaces for creating and editing content. To enable creation and editing content, existing document hosting systems often provide rigid and inefficient tools that require time intensive interactions to create or edit content.

Oftentimes, existing document hosting systems provide tools and functions for manual content creation. In many instances, tools for content creation on existing document hosting systems require time intensive user interactions to generate content from a blank slate via drawing tools, graphic design tools, and/or text tools. Indeed, utilizing digital graphic design tools and/or drawing tools to create content (e.g., when creating a large amount of content) can be time intensive and require a significant amount of computational resources during the creation of the content.

Furthermore, in many cases, existing document hosting systems provide rigid tools to create and edit content with limited functionalities. In particular, many existing document hosting systems provide unintelligent digital graphic design tools and/or drawing tools that simply enable users to draw and/or create simple shapes or geometry (e.g., to form images, art, videos). In addition, some existing document hosting systems may provide digital graphic design tools and/or drawing tools that enable users to draw and/or create simple shapes or geometry while snapping to existing shapes or lines or autocorrecting various content or characteristics of the content. However, such unintelligent digital graphic design and/or drawing tools are often rigid and also do not significantly reduce the time requirements of creating content.

### SUMMARY

This disclosure describes one or more embodiments of systems, methods, and non-transitory computer readable storage media that provide benefits and/or solve one or more of the foregoing and other problems in the art. In particular, the disclosed systems can utilize artificial intelligence to generate user-specific content (e.g., digital images, videos, documents, or other content) based on content collections associated with a user account. Indeed, in one or more implementations, the disclosed systems utilize machine learning to intelligently generate new, custom content items that emulate user-specific content attributes based on content collections associated with a user account. In some instances, the disclosed systems utilize a content generation model that is trained to generate new content items in response to user requests (e.g., requests that describe one or more features). Furthermore, the disclosed systems can fine tune or modify parameters of the content generation model with content items from the content collections associated with the user account (e.g., a user-specific corpus of content items) to create a custom content generation model that synthesizes at least one attribute of the user account's content items within generated, new content items.

To illustrate, in one or more embodiments, the disclosed systems receive a content creation request from a user account (e.g., a text prompt input). Furthermore, the disclosed systems can utilize the content creation request with the custom content generation model to generate a custom content item that depicts one or more features (by synthesizing the features) described in the content creation request while also synthesizing attributes of the user account's content items within the custom content item. In some implementations, the disclosed systems can receive user-selected content items and utilize the custom content generation model to generate a custom content item that includes one or more attributes of the user-selected content items.

### BRIEF DESCRIPTION OF THE DRAWINGS

The detailed description is described with reference to the accompanying drawings in which:

FIG. 1 illustrates a schematic diagram of an example system in which a custom content generation system operates in accordance with one or more implementations.

FIG. 2 illustrates an exemplary flow of a custom content generation system generating a custom content item in accordance with one or more implementations.

FIG. 3 illustrates an overview of a custom content generation system utilizing machine learning to generate new, custom content items having attributes of content from content collections associated with a user account in accordance with one or more implementations.

FIG. 4 illustrates an example of a custom content generation system utilizing a content generation model trained to generate new content items based on input content creation requests in accordance with one or more implementations.

FIG. 5 illustrates a custom content generation system fine-tuning a content generation model using user specific content to generate a custom content generation model that synthesizes one or more attributes of content items from a user account in accordance with one or more implementations.

FIG. 6 illustrates a custom content generation system utilizing a custom content generation model to generate a custom content item in accordance with one or more implementations.

FIG. 7 illustrates a custom content generation system utilizing a custom content generation model with user-selected content items to generate a custom content item in accordance with one or more implementations.

FIG. 8 illustrates a custom content generation system generating a new, custom content item depicting a combination of features depicted in one or more input content items in accordance with one or more implementations.

FIG. 9 illustrates a custom content generation system utilizing user-selected content attribute weights for a custom content generation model in accordance with one or more implementations.

FIG. 10 illustrates a custom content generation system utilizing user-selected request feature weights for a custom content generation model in accordance with one or more implementations.

FIG. 11 illustrates a custom content generation system providing various functionalities for a custom content item within a graphical user interface in accordance with one or more implementations.

FIG. 12 illustrates a flowchart of a series of acts for utilizing machine learning to intelligently generate new, custom content items that emulate user-specific content attributes based on content collections associated with a user account in accordance with one or more implementations.

FIG. 13 illustrates a block diagram of an exemplary computing device in accordance with one or more implementations.

FIG. 14 illustrates an example environment of a networking system in accordance with one or more implementations.

### DETAILED DESCRIPTION

This disclosure describes one or more embodiments of a custom content generation system that utilizes machine learning to intelligently generate new, custom content items having attributes of content from content collections associated with a user account. For instance, the custom content generation system can identify and utilize content items associated with a user account to fine tune parameters of a content generation model that is trained to generate new content items. In particular, the custom content generation system can modify the parameters of the content generation model using attributes of the content items associated with the user account (to generate a custom content generation model). Additionally, the custom content generation system can receive a custom content generation request to generate a new content item (from a client device of the user account). Subsequently, the custom content generation system can utilize the custom content generation model to generate a custom content item having the one or more attributes from the content items associated with the user account within the custom content item based on the custom content generation request. In addition, in one or more embodiments, the custom content generation system generates the custom content item (via the custom content generation model) to depict one or more features (or objects) described within the custom content generation request (e.g., a text prompt input and/or user-selected menu option requesting the portrayal of particular features in the new content item).

In one or more embodiments, the custom content generation system can identify various media content files as content items in content collections associated with a user account. In particular, the custom content generation system can identify one or more media content files uploaded from a user client device, stored on the user client device, and/or created on user client device for a user account. Moreover, the custom content generation system can identify various combinations of media content files as content items (e.g., image files, video files, text files). In some cases, the custom content generation system can also identify media content files that are shared or stored in one or more shared folders accessible by multiple user accounts.

Furthermore, as mentioned above, the custom content generation system can utilize a content generation model that is trained to generate new content items (e.g., new digital images, new digital videos, new documents). In some implementations, the custom generation model can generate a new content item from a text prompt input such that the new content item portrays (or depicts) one or more features described in the text prompt input (e.g., “make a painting of a dog wearing a hat”). In some cases, the custom content generation model can generate a new content item based on a combination of two or more user-selected content items (e.g., a mashup of an image of a dog and an image of sunglasses). In one or more embodiments, the custom content generation system can utilize various types of machine learning models for the custom content generation model, such as, but not limited to, a deep learning text-to-image model and/or a generative adversarial neural network.

In addition, the custom content generation system can fine tune a content generation model using content collections associated with a user account to create a custom content generation model that emulates one or more attributes (from the content collections associated with the user account) in a newly generated content item. For instance, the custom content generation system can train (or augment) the custom content generation model with content items associated with the user account to cause the custom content generation model to generate new content items that include at least one attribute from the content items of the user account. In one or more instances, the custom content generation system can fine tune the custom content generation model to emulate attributes, such as, but not limited to, style, texture, geometric layout, and/or color themes extracted from (or identified) in the content items associated with the user account (e.g., content items created by the user of the user account).

Moreover, in one or more embodiments, the custom content generation system receives a content creation request from a user account. For example, the custom content generation system can receive a text prompt input as a content creation request that describes one or more features to include while generating a new content item (e.g., “painting of a dog wearing a hat,” “sketching of a talking car,” “animation of a bear walking”). In some instances, the custom content generation system can receive user selections from selectable menu options as a content creation request (e.g., selectable options for various objects and verbs or actions for the objects). Additionally, in some cases, the custom content generation system can receive, as the content creation request, a request to create a new content item from two or more selected content items (e.g., create a new content item having the features of the selected content items, create a new content item by combining the selected content items).

Upon receiving a content creation request from a user account, the custom content generation system can utilize the custom content generation model to generate a new, custom content item based on the content creation request. For instance, the custom content generation system can utilize the custom content generation model with the content creation request to generate a custom content item that depicts the one or more features (e.g., by synthesizing the one or more features) described in the content creation request (e.g., creating an image that portrays a painting of a dog wearing a hat based on the text prompt input “painting of a dog wearing a hat”). Furthermore, the custom content generation system can utilize the custom content generation model to depict the one or more features described in the content creation request while synthesizing attributes from the content collections of the user account (e.g., an image that portrays a painting of a dog wearing a hat in the color scheme and texture detected within the content collections of the user account).

In addition, in some cases, the custom content generation system fine tunes a content generation model using content collections associated with multiple user accounts (e.g., collaborating user accounts) to create a custom content generation model that emulates one or more attributes (from the content collections associated with the multiple user accounts) in a newly generated content item. Indeed, the custom content generation system can train (or augment) the custom content generation model with content items associated with the multiple user accounts to cause the custom content generation model to generate new content items that include at least one attribute from the collective content items of the multiple user accounts. Then, upon receiving a content creation request from one or more of the user accounts, the custom content generation system can utilize the custom content generation model to generate a new, custom content item that depicts one or more features described in the content creation request (e.g., creating an image that portrays a painting of a dog wearing a hat based on the text prompt input “painting of a dog wearing a hat”) while also synthesizing attributes from the content collections of the multiple user accounts (e.g., an image that portrays a painting of a dog wearing a hat in the color scheme of content collections of a first user account and texture detected within content collections of a second user account).

Furthermore, in one or more implementations, the custom content generation system can enable various functionalities for a user account with respect to the generated custom content item. For instance, upon generating the custom content item, the custom content generation system can enable user accounts to share, save, modify, delete, and/or provide other feedback (e.g., like, dislike) for the generated custom content item. In some instances, the custom content generation system can utilize user interactions of one or more user accounts with the custom content item to further train (or fine tune) the custom content generation model (e.g., with negative interactions, such as, deleting or disliking a custom content item or positive interactions, such as, saving or liking the custom content item).

The custom content generation system provides several technical advantages over existing document hosting systems. For example, the custom content generation system provides flexible, fast, and efficient tools for digital content creation. Indeed, the custom content generation system provides a practical application that utilizes machine learning to intelligently generate new, custom content items that emulate user-specific content attributes based on content collections associated with a user account.

To illustrate, unlike many existing systems that require time intensive user interactions to generate content, the custom content generation system can generate numerous user-specific customized digital content for a user account through content creation requests (e.g., simple text prompt inputs). For instance, in contrast to tools and functions in existing systems that require manual content creation, the custom content generation system enables users to provide content creation request input (e.g., a simple text prompt, such as “painting of a dog wearing a hat” or a simple voice command, such as “drawing of a lion playing tennis”) to a custom content generation model that quickly generates digital content according to the content creation request while also emulating user-specific content attributes learned from content collections associated with a user account. Indeed, the custom content generation system can quickly and easily generate custom digital content for a user via text (or other) prompts to improve the flexibility of generating and experimenting with different content creation ideas without being time intensive.

In addition to improved flexibility and speed of custom digital content creation, the custom content generation system also improves computational efficiency. For instance, in contrast to existing systems that utilize digital graphic design tools and/or drawing tools to create content with a significant amount of screen time and processing time, the custom content generation system enables creation of new, custom content items that emulate user-specific content attributes through reduced user interaction, reduced user navigation, and reduced screen time. Due to the reduced user interaction, reduced user navigation, and reduced screen time, the custom content generation system efficiently utilizes less computational resources (e.g., processing resources for digital graphic design tools and/or drawing tools, battery usage due to screen time) while generating numerous new, custom content items that emulate user-specific content attributes and depict features described in a content creation request input.

As illustrated by the foregoing discussion, the present disclosure utilizes a variety of terms to describe features and benefits of the custom content generation system. Additional detail is now provided regarding the meaning of these terms. As used herein, the term “content” (or sometimes referred to as “content item,” “content,” “media content file,” “digital content,” or “media content”) refers to discrete data representation of a document, file, image, or video. In particular, a digital content item can include, but is not limited to, a digital image (file), a digital video (file), an electronic document (e.g., text file, spreadsheet, PDF, forms), and/or electronic communication. In one or more embodiments, the term “new content item” (or “custom content item”) refers to digital content synthesized or created by a machine learning model (e.g., the content generation model or the custom content generation model). In some cases, a content item (or new content item) can also include electronic documents that represent user interface designs and/or website user interface designs (e.g., images of user interface designs and/or website user interface designs).

As further used herein, the term “image” (or sometimes referred to as “image file” or “digital image”) refers to discrete data representation of a visual representation. For example, an image can include, but not limited to, data represented in a digital file with the following file extensions: JPEG, PNG, TIFF, RAW, or PDF. Furthermore, as used herein, the term “video” (or sometimes referred to as “video file” or “digital video”) refers to discrete data representation of a visual representation of multiple frames (or images). For example, a video can include, but is not limited to, data represented in a digital file with the following file extensions: AVI, WMV, MOV, QT, MP4, or AVCHD.

As used herein, the term “content generation model” refers to a machine learning model that generates digital content items from input creation requests. In particular, a “content generation model” can refer to a text-to-content model trained to utilize input text descriptions (i.e., input creation requests) to generate content (e.g., images or videos) that portrays (or depicts) features described in the input text descriptions. As an example, upon receiving an input text description “painting of a dog wearing a hat,” the content generation model can generate a digital content item (e.g., an image) that visually portrays a dog wearing a hat (stylized as a painting).

In addition, as used herein, the term “custom content generation model” refers to a content generation model that is fine-tuned or augmented to generate digital content items from input creation request while also emulating one or more attributes from particular content. In particular, the term “custom content generation model” refers to a content generation model that is fine-tuned (or augmented) using content associated with a user account (e.g., created by a user of the user account, stored on the user account) to generate digital content items that emulate one or more attributes from the content associated with a user account and portray features described in an input creation request. As an example, upon receiving an input text description “painting of a dog wearing a hat,” the custom content generation model can generate a digital content item (e.g., an image) that visually portrays a dog wearing a hat (stylized as a painting) that emulates a painting style detected in the content associated with a user account (e.g., a watercolor style with dark colors, an oil painting style with vibrant colors). In one or more embodiments, a content generation model and/or a custom content generation model can include one or more machine learning models (e.g., various combinations of machine learning models).

Furthermore, as used herein, the term “machine learning model” refers to a computer representation that can be tuned (e.g., trained) based on inputs to approximate unknown functions. Indeed, a machine learning model can refer to a computer representation that can be tuned (e.g., trained) based on inputs to generate images (or other visual representations, such as videos). Additionally, a machine learning model can refer to a computer representation that can be tuned (e.g., trained) based on inputs to analyze text and/or images. In one or more implementations, parameters of a machine learning model can be adjusted or trained to create a custom content generation model that intelligently generate new, custom content items from creation request prompts (e.g., text prompts) that also emulate one or more attributes from particular content.

For instance, a machine learning model can include, but is not limited to, one or more convolutional neural networks, recurrent neural networks, generative adversarial neural networks), residual neural networks, diffusion models, or a combination thereof. Additionally, a machine learning model can also include, but is not limited to one or more differentiable function approximators, contrastive language-image pre-training models, clustering models, convolution neural network-based image classifiers, recurrent neural network-based image classifiers, Term Frequency Inverse Document Frequency (TF-IDF) encoders, Word2Vecs, matrix factorization vector learning approaches, local context window vector learning approaches, Global Vectors for Word Representation (GloVe), Bidirectional Encoder Representations from Transformers, natural language processing approaches (e.g., spaCy), and/or generative pre-trained transformer models.

Moreover, as used herein, the term “attribute” refers to one or more visual characteristics within a content item. In particular, an attribute can include visual characteristics, such as, but not limited to, a texture, a style, a color theme, moods, materials, sizing, scale, tone, aspect ratios, and/or shapes and geometry visually represented within a content item. For example, an attribute can include a color theme of an image. As another example, an attribute can include a style (or medium), such as, an oil painting style, a pencil sketch style, ink sketch style, watercolor style, photograph style, black and white photograph style that is visually represented in an image. In some cases, an attribute can include a visual style or theme in an image that represents a style or theme of a particular artist or art period (e.g., Picasso style, Monet style, Baroque style, Contemporary Art style, Calligraphy art style, prehistoric art style, ukiyo-e art style).

As used herein, the term “feature” refers to one or more visual representations (or portrayal) of persons, objects, concepts or settings, adjectives, or actions within a content item. In particular, a feature can include visual representations of persons or objects, such as, but not limited to, men, women, children, robots, animals, cars, buildings, trees, bicycles, and/or airplanes. In addition, a feature can include visual representations of concepts or settings (or environments), such as, but not limited to, space, an ocean, a moon, a forest, a birthday party, a wedding, a workplace, and/or an office. Furthermore, a feature can include visual representations of actions, such as, but not limited to, running, hiking, jumping, laughing, crying, speaking, throwing, and/or eating. In addition, a feature can include visual representations of adjectives, such as, but not limited to, giant, tiny, abandoned, broken, happy, magical, ominous, and/or glossy.

Additionally, as used herein, the term “request” (sometimes referred to as “request to generate,” “content creation request,” or “creation request input”) refers to an input prompt including a content description that describes content to depict within a generated content item. In one or more embodiments, the content creation request refers to an input prompt that includes a content description which describes one or more features (and attributes) to include within a new content item (generated by the custom content generation model as described herein). In some cases, the content creation request includes a text prompt input (based on user typed text or text identified from a voice command) that describes one or more features (and attributes) to include within a new content item (e.g., “painting of a dog wearing a hat” or “draw a monkey eating an apple”). In one or more implementations, the content creation request includes a text prompt input generated from one or more user selections of selectable feature (e.g., a selectable option to select one or more objects and/or scenes) and/or attribute options (e.g., a selectable option to select one or more styles and/or color schemes).

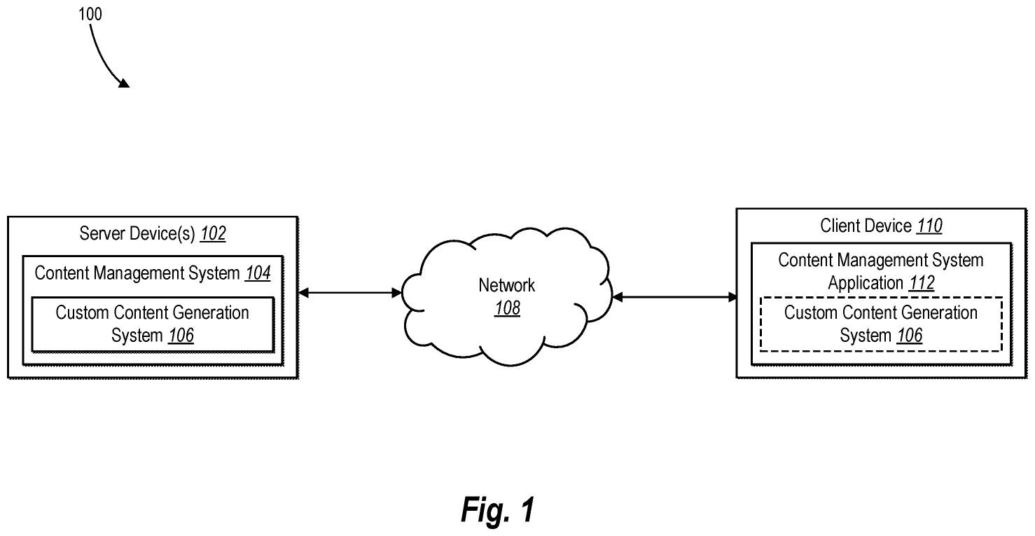

Turning now to the figures, FIG. 1 illustrates a schematic diagram of one implementation of a system 100 (or environment) in which a custom content generation system 106 operates in accordance with one or more implementations. As illustrated in FIG. 1, the system 100 includes server device(s) 102, a network 108, and a client device 110. As further illustrated in FIG. 1, the server device(s) 102 and the client device 110 communicate via the network 108.

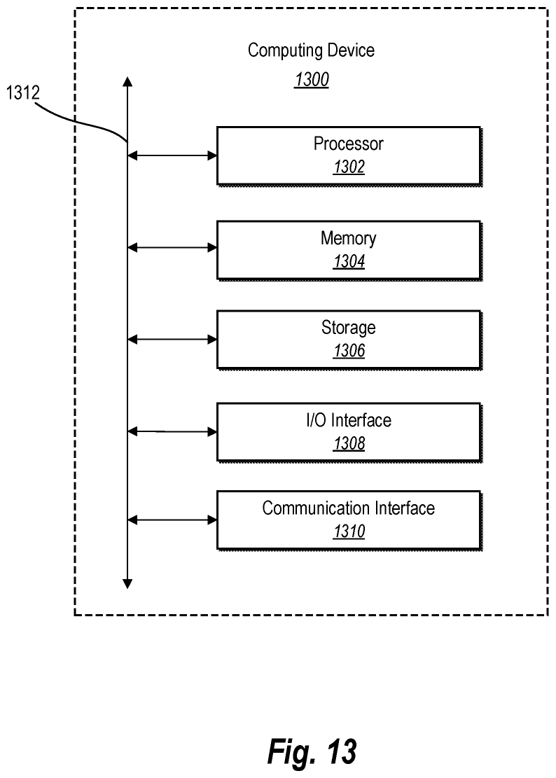

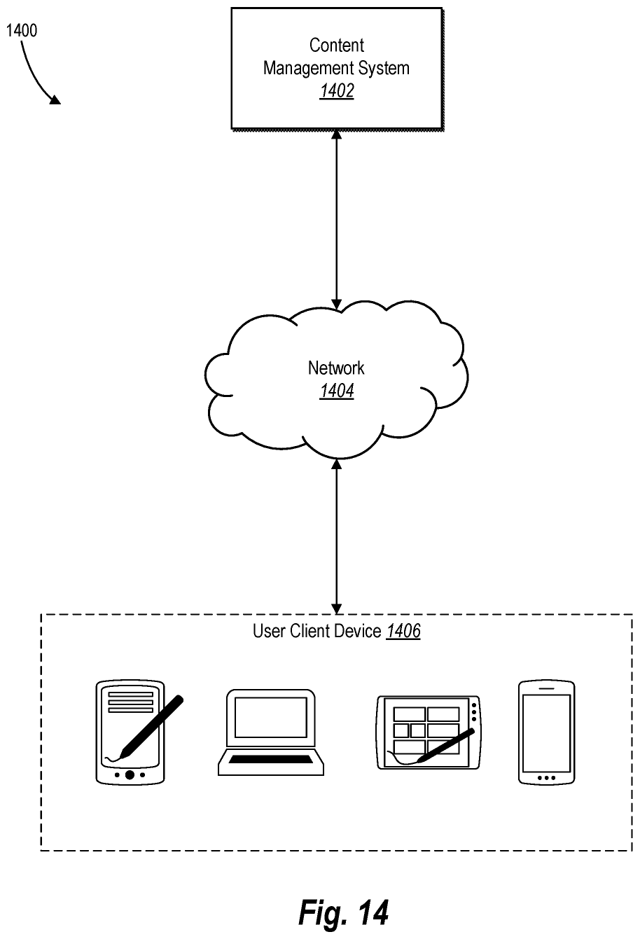

As shown in FIG. 1, the server device(s) 102 include a content management system 104, which further includes the custom content generation system 106. In particular, the content management system 104 provides functionality by which a user (not shown in FIG. 1) can use the client device 110 to generate, manage, and/or store digital content. For example, a user can generate digital content using the client device 110. Subsequently, a user utilizes the client device 110 to send the digital content to the content management system 104 hosted on the server device(s) 102 via the network 108. The content management system 104 can then provide many options that the client device 110 may utilize (and a user selects or otherwise interacts with) to store the digital content, organize the digital content, share the digital content, and subsequently search for, access, view, and/or modify the digital content. Additional detail regarding the content management system 104 is provided below (e.g., in relation to FIG. 14 and the content management system 1402). Furthermore, the server device(s) 102 can include, but are not limited to, a computing (or computer) device (as explained below with reference to FIG. 13).

As further shown in FIG. 1, the system 100 includes the client device 110. In one or more implementations, the client device 110 include, but are not limited to, mobile devices (e.g., smartphones, tablets), laptops, desktops, or other types of computing devices, as explained below with reference to FIG. 13 For example, the client device 110 can be operated by users to perform various functions (e.g., via the content management system application 112) such as, but not limited to, creating, receiving, viewing, modifying, and/or transmitting digital content, receiving and/or transmitting content creation requests, configuring user account or application settings of the content management system 104, and/or electronically communicating with other user accounts of the content management system 104. Although FIG. 1 illustrates a single client device 110, in one or more embodiments, the system 100 can include various numbers and types of client devices.

To access the functionalities of the content management system 104 (and the custom content generation system 106), a user can interact with the content management system application 112 via the client device 110. The content management system application 112 can include one or more software applications installed on the client device 110. In some implementations, the content management system application 112 can include one or more software applications that are downloaded and installed on the client device 110 to include an implementation of the custom content generation system 106. In some embodiments, the content management system application 112 is hosted on the server device(s) 102 and is accessed by the client device 110 through a web browser and/or another online platform. Moreover, the content management system application 112 can include functionalities to access or modify a file storage structure stored locally on the client device 110 and/or hosted on the server device(s) 102.

As just mentioned and as shown in FIG. 1, the server device(s) 102 include the custom content generation system 106 (through the content management system 104). In one or more embodiments, the custom content generation system 106 receives content items from the client device 110 (e.g., to store in a collection of content items). Furthermore, the custom content generation system 106 can receive a content creation request from the client device 110. In addition, the custom content generation system 106 can utilize machine learning (e.g., via one or more machine learning models) to intelligently generate new, custom content items that depicts features from a content creation request and also having attributes of content from content collections associated with a user account of the client device 110 (in accordance with one or more implementations herein).

Although FIG. 1 illustrates the custom content generation system 106 being implemented by a particular component and/or device within the system 100 (e.g., the server device(s) 102), in some embodiments, the custom content generation system 106 is implemented, in whole or part, by other computing devices and/or components in the system 100. For example, in some implementations, the custom content generation system 106 is implemented on the client device 110 within the content management system application 112. More specifically, in some embodiments, some or all of the custom content generation system 106 is implemented by the server device(s) 102 and accessed by the client device 110 through the content management system application 112, web browsers, and/or other online platforms (as described above). In some instances, some or all of the custom content generation system 106 is implemented by the client device 110 on the content management system application 112 and communicates data (or changes to data) to the content management system 104 on the server device(s) 102.

Additionally, as illustrated in FIG. 1, the system 100 includes the network 108 that enables communication between components of the system 100. In certain implementations, the network 108 includes a suitable network and may communicate using any communication platforms and technologies suitable for transporting data and/or communication signals between the server device(s) 102 and the client device 110. An example of the network 108 is described with reference to FIG. 13 and/or FIG. 14. Furthermore, although FIG. 1 illustrates the server device(s) 102 and the client device 110 communicating via the network 108, in certain implementations, the various components of the system 100 communicate and/or interact via other methods (e.g., the server device(s) 102 and the client device 110 communicating directly).

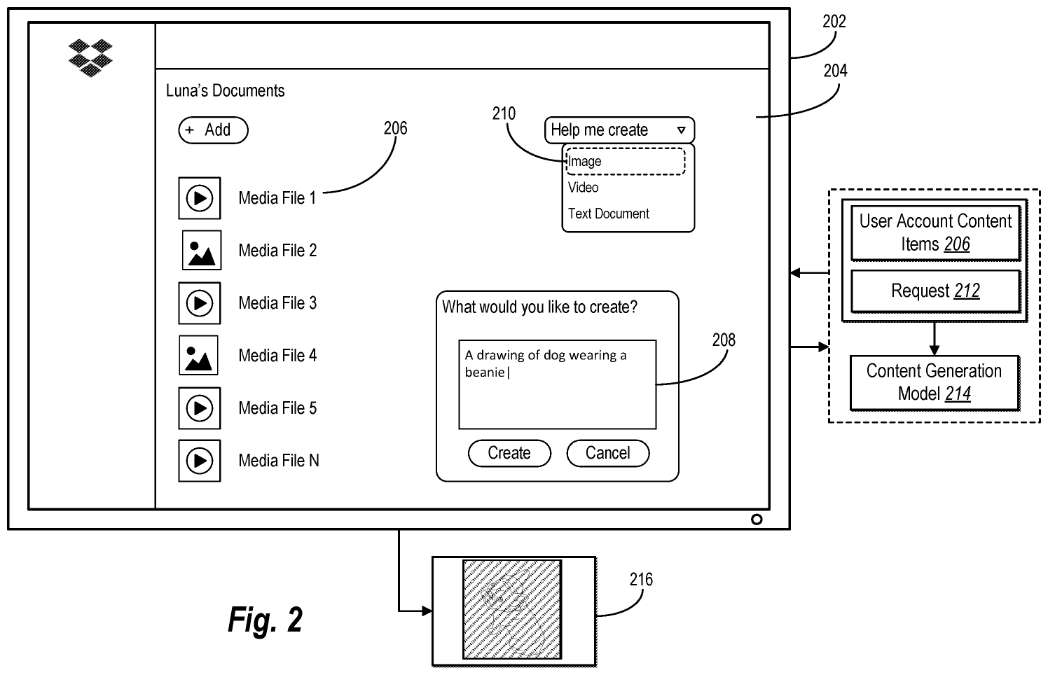

As mentioned above, the custom content generation system 106 can intelligently generate content items based on content collections associated with a user account within a content management system. For example, FIG. 2 illustrates exemplary workflow of the custom content generation system 106. Indeed, FIG. 2 illustrates the custom content generation system 106 generating a custom content item based on content collections associated with a user account (and a user input content creation request).

For instance, as shown in FIG. 2, the custom content generation system 106 identifies one or more content items 206 (e.g., image files, video files, documents) associated with a user account (e.g., Luna's Documents). In addition, as shown in FIG. 2, the custom content generation system 106 provides, for display within a graphical user interface (GUI) 204 on a client device 202, a text input object 208 (to receive a content creation request) upon receiving a user interaction with a selectable option 210 to initiate a content creation request. As shown in FIG. 2, the custom content generation system 106 receives a content creation request (e.g., “drawing of a dog wearing a beanie”) as the request 212 within the text input object 208.

Furthermore, as shown in FIG. 2, upon receiving the request 212 from the client device, the custom content generation system 106 utilizes the request 212 and the user account content items 206 with the content generation model 214 to generate a new, custom content item 216. As shown in FIG. 2, the new, custom content item 216 portrays one or more features described in the request 212 (e.g., “drawing of a dog wearing a beanie”). In addition, the new, custom content item 216 is stylized by the content generation model 214 utilizing one or more attributes corresponding to the user account content items 206.

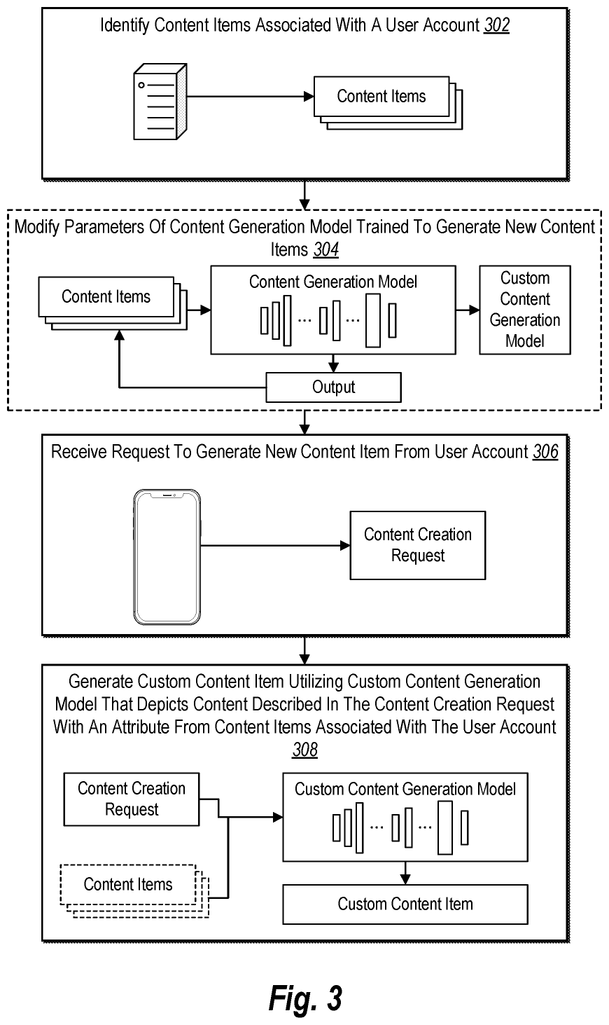

Moreover, FIG. 3 illustrates an overview of the custom content generation system 106 utilizing machine learning to generate new, custom content items having attributes of content from content collections associated with a user account (based on user input content creation requests). In particular, FIG. 3 illustrates the custom content generation system 106 identifying content items associated with a user account, using the content items to modify parameters of a content generation model that is trained to generate new content items, receive a request to generate a new content item from the user account, and generating a custom content item utilizing the custom content generation model that depicts content described in the content creation request with an attribute from content items associated with the user account.

As shown in act 302 of FIG. 3, the custom content generation system 106 identifies content items associated with a user account. In particular, the custom content generation system 106 can identify one or more content items that are associated with a user account via storage space corresponding to the user account, content items created through the user account, and/or content items uploaded from a client device of the user account. Indeed, the content management system 104 can enable a user account (of a user) to generate, manage, and/or store digital content items within one or more storage repositories of the content management system 104. Furthermore, the custom content generation system 106 can identify the digital content items via meta data and/or other indicators that point the digital content items to the particular user account. In some cases, the custom content generation system 106 can identify digital content items corresponding to multiple user accounts when utilizing a content generation model for a content collaboration between multiple user accounts.

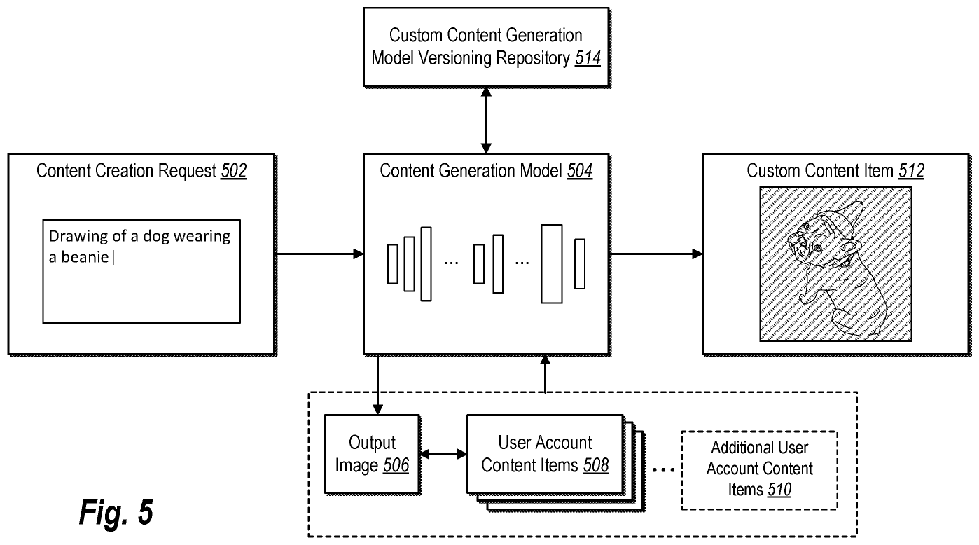

Furthermore, as shown in act 304 of FIG. 3, the custom content generation system 106 can modify parameters of a content generation model trained to generate new content items. For instance, as shown in the act 304, the custom content generation system 106 can utilize content items associated with the user account to modify parameters of a content generation model (e.g., via comparisons between output and the content items) to generate a custom content generation model that outputs new content items that contain one or more attributes of the content items associated with the user account. Indeed, the custom content generation system 106 can modify parameters of a content generation model based on content items associated with a user account as described below (e.g., in relation to FIGS. 5 and 9-11).

Additionally, as shown in act 306 of FIG. 3, the custom content generation system 106 receives a request to generate a new content item from the user account (associated with the content items). To illustrate, the custom content generation system 106 can receive a content creation request to generate a new content item that describes content to portray within the new content item. In some cases, the custom content generation system 106 receives a text prompt request (as the content creation request) that describes features (and/or attributes) to include in the new content item. Indeed, the custom content generation system 106 can receive a content creation request as described below (e.g., in relation to FIGS. 5-8).

In addition, as shown in act 308 of FIG. 3, the custom content generation system 106 generates custom content items utilizing the custom content generation model that depicts content described in the content creation request with an attribute from content items associated with the user account. In particular, the custom content generation system 106 can utilize a content creation request and content items associated with the user account to generate a new content item that portrays or depicts features described in the content creation request with visual characteristics (i.e., attributes) that are similar to (or emulated from) the content items associated with the user account. In some cases, the custom content generation system 106 utilizes a request to create a new, custom content item from a selection of digital content from a user to generate a new content item that portrays combined features and/or attributes form the selected content items of the user account. Indeed, generating custom content items utilizing a custom content generation model with one or more content items associated with the user account is described below (e.g., in relation to FIGS. 5-11).

As mentioned above, the custom content generation system 106 can utilize a content generation model to generate new content items. For instance, the custom content generation system 106 can utilize a content generation model that is trained to utilize text prompts to generate digital content (e.g., images, videos, other documents) that represent features described within the text prompts. To illustrate, the custom content generation system 106 can utilize an input text prompt request with the content generation model to generate a new content item (e.g., an image) that depicts a visual representation of one or more features described in the input text prompt. Indeed, the custom content generation system 106 can utilize a machine learning-based content generation model that is trained to analyze input text and generate content for the input text.

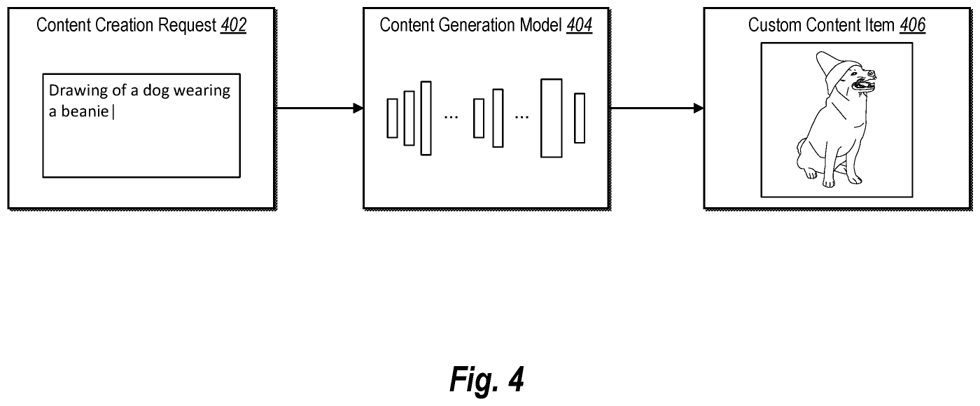

For example, FIG. 4 illustrates an example of a content generation model trained to generate new content items based on input content creation requests. As shown in FIG. 4, the custom content generation system 106 provides a content creation request 402 (e.g., a text input of “drawing of a dog wearing a beanie”) as input to a content generation model 404. Subsequently, the content generation model 404 analyzes the content creation request 402 and generates a custom content item 406 (e.g., an image). In particular, as shown in FIG. 4, the content generation model 404 generates a digital image (as the custom content item 406) that visually represents (or depicts) features described in the content creation request 402 (e.g., a dog wearing a beanie as a drawing).

In one or more embodiments, the custom content generation system 106 utilizes a content generation model that is trained using various image and text pairs as training data. In particular, the custom content generation system 106 can train the content generation model to learn relationships between text descriptions and images that correspond to the text descriptions. Indeed, in some implementations, the custom content generation system 106 utilizes the content generation model to generate images from noise conditioned on the text descriptions using a text encoding model (e.g., a contrastive language-image pre-training model or other natural language processing approach).

For example, the custom content generation system 106 can cause the content generation model to generate an output image in response to a text description. Then, the custom content generation system 106 can compare the output image to a ground truth image corresponding to the text description (e.g., from the image and text paired training data) to determine a loss between the output image and the ground truth image (e.g., a cross entropy loss, mean square error loss, mean absolute error loss). Moreover, the custom content generation system 106 can utilize the determined loss to modify parameters of the content generation model to improve the accuracy of the content generation model generating an output image that visually represents the features described in the training text description (e.g., using back propagation). Indeed, the custom content generation system 106 can iteratively learn (or modify) parameters of the content generation model using various training image and text description pairings.

In some embodiments, the custom content generation system 106 utilizes a diffusion model-based content generation model to generate content items from input text prompts. For instance, the custom content generation system 106 can utilize a diffusion model that learns to denoise training images that are blurred with noise (e.g., Gaussian noise) as the content generation model. In particular, the custom content generation system 106 utilizes the diffusion model-based content generation model to denoise (e.g., reverse diffusion of) a training image that is blurred with noise.

In addition, the custom content generation system 106 can also utilize a text encoder model with the diffusion model to train the content generation model. In particular, the custom content generation system 106 can condition the denoising of the image (e.g., using the diffusion model) using the input training text descriptions. For instance, the custom content generation system 106 can utilize a text encoder model (e.g., a contrastive language-image pre-training model or other natural language processing approach) to embed text descriptions into an embedding space. In addition, the custom content generation system 106 can utilize the embedding space to learn relationships between embedded concepts (or features) from the embedded text descriptions and the denoised images. Indeed, the custom content generation system 106 can train the diffusion model to denoise random noise into output images that depict representations of one or more features described in the training text descriptions.

In some cases, the custom content generation system 106 can utilize a generative pre-trained transformer model as the content generation model. In particular, the custom content generation system 106 can utilize a generative pre-trained transformer model (as part of the content generation model) that utilizes attention learning to analyze text input. Indeed, the custom content generation system 106 can utilize a generative pre-trained transformer model that utilizes attention mechanisms to analyze text input with an objective to synthesize content from the text input. In one or more embodiments, the custom content generation system 106 utilizes a generative pre-trained transformer model that utilizes attention mechanisms to analyze text input with an objective to synthesize pixels (e.g., to form an image) that portray the concepts or features described in the text input.

In one or more implementations, the custom content generation system 106 can utilize a generative adversarial neural network (GAN) model as the content generation model. For instance, the custom content generation system 106 can utilize a GAN model trained to generate content items (e.g., images) utilizing a generator model that generates output (original) content items that are learned from a training data set of content (e.g., example images) and utilizing a discriminator model that determines whether the output content item is from the training domain dataset (e.g., mimics a real image) or is generated (e.g., determined as a fake image). In one or more instances, the custom content generation system 106 trains a GAN model to generate images until a discriminator model determines the output images as real images (e.g., tricking the discriminator model to determine generated images as real images).

Furthermore, the custom content generation system 106 can utilize a dataset of training images (and text descriptions) to train the content generation model. In particular, the custom content generation system 106 can utilize a dataset of training images that include images depicting various content and attributes (e.g., different environments, objects, actions, adjectives, persons, styles). In addition, the custom content generation system 106 can utilize a dataset of training images that includes text descriptions for the various content.

Although one or more embodiments herein illustrate the custom content generation system 106 utilizing a content generation model (or custom content generation model) to generate images, the custom content generation system 106 can utilize the content generation model to generate various content. For instance, the custom content generation system 106 can utilize the content generation model to generate digital videos (or animations) in response to a content creation request (e.g., a text prompt). In some instances, the custom content generation system 106 can utilize the content generation model to generate text documents in response to the content creation request (e.g., a text prompt).

Furthermore, although one or more embodiments herein illustrate the custom content generation system 106 utilizing a text prompt as a content creation request for the content generation model (or custom content generation model), the custom content generation system 106 can utilize various types of content creation requests for the content generation model. For instance, the custom content generation system 106 can utilize voice commands detected from a user of a client device as a content creation request. In some cases, the custom content generation system 106 can utilize user-selected menu options to build a content creation request via a selection of various features and/or attributes for the content creation request (e.g., a selection of various objects, settings, styles).

In some instances, the custom content generation system 106 can also receive content omission requests. For instance, the custom content generation system 106 can receive a content omission request that describes features and/or attribute that are not to be included in the generated new content item from the content generation model. For example, the custom content generation system 106 can receive a content omission request, such as “not in watercolor style” or “without the color pink.” In response to the content omission request, the custom content generation system 106 can utilize the content generation model to generate new content items that portray features described in a content creation request while avoiding features and/or attributes described in the content omission request.

As mentioned above, the custom content generation system 106 can fine tune a content generation model using content collections associated with a user account to create a custom content generation model that emulates one or more attributes (from the content collections associated with the user account) in a newly generated content item. For instance, the custom content generation system 106 can utilize content items associated with a user account to train (or fine tune) a content generation model to synthesize (or emulate) attributes present in the content items associated with the user account. In particular, the custom content generation system 106 can modify parameters of the content generation model using content items associated with the user account as training data to create a custom content generation model for the user account.

For example, FIG. 5 illustrates the custom content generation system 106 fine-tuning a content generation model using user specific content to generate a custom content generation model that synthesizes one or more attributes of content items from a user account within new, custom content items. To illustrate, as shown in FIG. 5, the custom content generation system 106 utilizes a content creation request 502 with a content generation model 504 to generate an output image 506 (e.g., a new content item). Moreover, the custom content generation system 106 compares the output image 506 to user account content items 508 to determine loss values between content attributes from the output image 506 and content attributes from the user account content items 508.

In addition, the custom content generation system 106 utilizes the loss values (e.g., via back propagation) to modify parameters of the content generation model 504 with an objective to mimic the content attributes from the user account content items 508 in the output image 506. Indeed, the custom content generation system 106 iteratively generates the output image 506 from the content generation model 504 and compares the content attributes of the output image 506 to the content attributes of the user account content items 508 to minimize a loss value (e.g., reach or satisfy a threshold loss) between the content attributes. Upon satisfying a loss value, the custom content generation system 106 generates a custom content generation model that is capable of generating a custom content item 512 (from the content creation request 502) that synthesizes one or more attributes from the user account content items 508.

For instance, in some cases, the custom content generation system 106 compares one or more attributes (or a representation of the attributes) of the output image 506 to one or more attributes (or a representation of the attributes) of the user account content items 508 to determine a loss value. In some embodiments, the custom content generation system 106 determines the loss value using various loss functions, such as, but not limited to, a cross entropy loss function, a mean square error loss function, and/or a mean absolute error loss function. Then, the custom content generation system 106 modifies or fine tunes the parameters of the content generation model 504 with an objective to emulate the one or more attributes (or a representation of the attributes) of the user account content items 508 (e.g., by reducing the loss value between the output image 506 and the user account content items 508). Upon reducing the loss value between the output image 506 and the user account content items 508, the custom content generation system 106 causes the content generation model 504 to generate content items (e.g., images) that depict one or more features described in a content creation request while also emulating the one or more attributes represented in the content items associated with the user account (e.g., mimicking the content style of the user account).

Furthermore, in one or more implementations, the custom content generation system 106 can fine tune a content generation model using content collections associated with multiple user accounts (e.g., content items from more than one user) to create a custom content generation model that emulates one or more attributes from the content collections associated with the multiple user accounts in a newly generated content item. For instance, the custom content generation system 106 can utilize multiple content items associated with the multiple user accounts to train (or fine tune) a content generation model to synthesize (or emulate) attributes present in the content items associated with the multiple user accounts. In particular, the custom content generation system 106 can modify parameters of the content generation model using content items associated with the multiple user account as training data to create a custom content generation model for the user accounts.

As an example, FIG. 5 illustrates the custom content generation system 106 utilizing user content items from multiple user accounts to fine tune a content generation model to create a custom content generation model that emulates one or more attributes (from the content collections associated with the multiple user accounts) in a newly generated content item. For example, as shown in FIG. 5, the custom content generation system 106 can compare the output image 506 to both user account content items 508 and additional user account content items 510 to determine loss values between content attributes from the output image 506 and content attributes from both the user account content items 508 and the additional user account content items 510. In addition, the custom content generation system 106 can utilize the loss values (e.g., via back propagation) to modify parameters of the content generation model 504 with an objective to mimic the combined content attributes from the user account content items 508 and the additional user account content items 510 in the output image 506 (in accordance with one or more implementations herein).

In one or more embodiments, the custom content generation system 106 can fine tune a content generation model using user-selected content items by one or more user accounts to create a custom content generation model that emulates one or more attributes from the user-selected content items in a newly generated content item. For instance, the custom content generation system 106 can receive user selections (e.g., by one or more users of one or more user accounts) of a set of user-selected content items. Moreover, the custom content generation system 106 can utilize the set of user-selected content items to train (or fine tune) a content generation model to synthesize (or emulate) attributes present in the set of user-selected content items (e.g., using a loss-based fine-tuning approach described above). In particular, the custom content generation system 106 can modify parameters of the content generation model using the set of user-selected content items as training data to create a custom content generation model for the user accounts.

Although one or more implementations herein illustrate the custom content generation system 106 utilizing a text-based content creation request as part of the fine-tuning process to generate a custom content generation model, the custom content generation system 106, in some cases, fine tune a content generation model using content collections associated with a user account to create a custom content generation model that emulates one or more attributes (from the content collections associated with the user account) in a newly generated content item without utilizing a text-based content creation request. For example, the custom content generation system 106 can utilize a content generation model to generate a new content item based on an input content item (or content items). Then, the custom content generation system 106 can utilize content items associated with a user account to train (or fine tune) a content generation model to synthesize (or emulate) attributes present in the content items associated with the user account (as described above).

For instance, the custom content generation system 106 can generate a new content item based on a combination of two or more content items utilizing the content generation model that depicts features from the combination of the two or more content items. Then, the custom content generation system 106 can compare the new content item with content items associated with a user account to determine loss values between content attributes from the new content item and content attributes from the user account content items. Indeed, the custom content generation system 106 can further utilize the loss values (e.g., via back propagation) to modify parameters of the content generation model with an objective to mimic the content attributes from the user account content items in the new content item (in accordance with one or more embodiments herein).

In some cases, the custom content generation system 106 can, as part of the fine-tuning process, also embed various user account specific requests for the user account specific attributes. For instance, the custom content generation system 106 can train the custom content generation model to relate attributes or stylistic commands in a content creation request (e.g., “in my style,” “in my color preference,” “in my painting style,” “in my drawing style,”) to the utilization of specific attributes from the content items of the user account in newly generated custom content items. Moreover, the custom content generation system 106 can also train the custom content generation model to relate attributes or stylistic commands in a content creation request (e.g., “in the group's style,” “in user 1's style,” “in user 2's style,” “in user 1's color preference and user 2's painting style”) to the utilization of specific attributes from content items of multiple user accounts in newly generated custom content items.

Furthermore, the custom content generation system 106 can version various renditions of a custom content generation model. For instance, upon fine tuning the content generation model to emulate one or more attributes (from the content collections associated with a user account) in a newly generated content item, the custom content generation system 106 can store the custom content generation model for the user account (with a version indicator). For example, as shown in FIG. 5, upon modifying parameters of the content generation model 504, the custom content generation system 106 can store the custom content generation model within a custom content generation model versioning repository 514. In particular, the custom content generation system 106 can version and store custom content generation models (e.g., a version history of various updates to custom content generation models) for a user account based on date of training, content items utilized, and/or user accounts utilized.

Moreover, the custom content generation system 106 can enable a user account to retrieve various versions of the custom content generation model. To illustrate, the custom content generation system 106 can receive, from a client device of a user account, a request with a selection of a particular version of the custom content generation model from the custom content generation model versioning repository 514. In response to the request for the particular version, the custom content generation system 106 can utilize the particular version of the custom content generation model to generate a new content item from a content creation request.

As an example, the custom content generation system 106 can receive a request from a user account to utilize a particular version of the custom content generation model that utilized a particular set of content items (e.g., content items that existed on a particular date and/or content items that were user-selected during fine tuning) for fine tuning and, in response, the custom content generation system 106 can utilize the particular version of the custom content generation model that emulates attributes for the particular set of content items. As another example, the custom content generation system 106 can receive a request from a user account to utilize a particular version of the custom content generation model that was trained (or fine-tuned) on a particular date and, in response, the custom content generation system 106 can utilize the particular version of the custom content generation model from the selected date. Moreover, as another example, the custom content generation system 106 can receive a request from a user account to utilize a particular version of the custom content generation model that was trained (or modified) using content items from a particular set of user accounts and, in response, the custom content generation system 106 can utilize the particular version of the custom content generation model that emulates attributes for a set of content items from the particular set of user accounts.

Indeed, the custom content generation system 106 can generate a custom content generation model that receives a content creation request and generates a new, custom content item that depicts one or more features described in the content creation request while also emulating attributes from content items associated with a user account. To illustrate, the custom content generation system 106 can receive a content creation request indicating “painting of a turtle on a skateboard in my style.” In response to the content creation request (e.g., “painting of a turtle on a skateboard in my style”), the custom content generation system 106 can utilize the custom content generation model to generate an image of a turtle on a skateboard as a painting that uses a specific style of painting (e.g., an attribute) that is present in other content items associated with the user account.

In addition, the custom content generation system 106 can generate a custom content generation model that receives a content creation request and generates a new, custom content item that depicts one or more features described in the content creation request while also emulating attributes from content items associated with multiple user accounts. To illustrate, the custom content generation system 106 can receive a content creation request indicating “drawing of a koala singing in the group's style.” In response to the content creation request (e.g., “drawing of a koala singing in the group's style”), the custom content generation system 106 can utilize the custom content generation model to generate an image of a koala singing as a drawing that uses a specific style of drawing lines (e.g., an attribute) from content items of first user account and a specific color theme (e.g., an attribute) from content items of a second user account.

Moreover, the custom content generation system 106 can generate a custom content generation model that receives one or more input content items (a subset of content items) and generates a new, custom content item that depicts a combination of features described in the one or more input content items while also emulating attributes from content items associated with a user account. To illustrate, the custom content generation system 106 can receive a content creation request that requests a new content item generated using a combination of a first user-selected input image portraying a dog and a second user-selected input image portraying sunglasses. In response to the first and second user-selected input images, the custom content generation system 106 can utilize the custom content generation model to generate an image of a dog wearing sunglasses in a specific style of painting (e.g., an attribute) that is present in other content items associated with the user account.

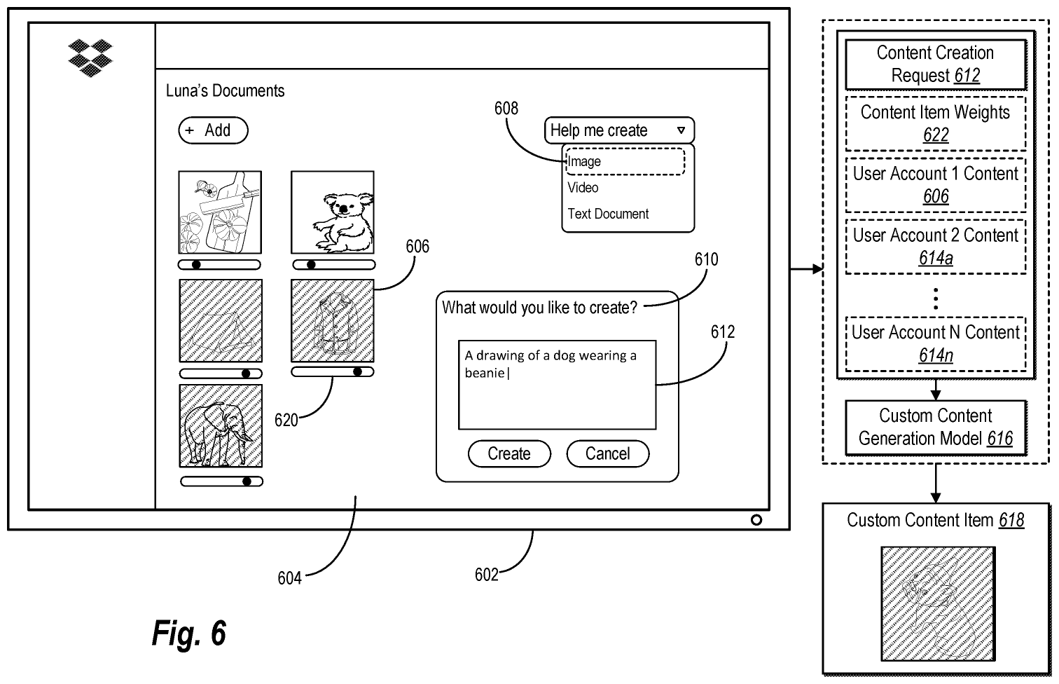

As mentioned above, the custom content generation system 106 can utilize a custom content generation model to generate a new, custom content item that depicts one or more features described in a content creation request while also emulating attributes from content items associated with a user account. For example, FIG. 6 illustrates the custom content generation system 106 utilizing a custom content generation model to generate a custom content item that depicts (by synthesizing) one or more features described in a content creation request while also emulating attributes from content items associated with a user account. Indeed, FIG. 6 illustrates the custom content generation system 106 utilizing a custom content generation model that is trained to depict one or more features described in a content creation request while also emulating attribute from the content items associated with a user account.

As shown in FIG. 6, the custom content generation system 106 provides, for display within a graphical user interface (GUI) 604 on a client device 602, a text input object 610 (to receive a content creation request) upon receiving a user interaction with a selectable option 608 to initiate a content creation request. As shown in FIG. 6, the custom content generation system 106 receives a content creation request 612 (e.g., “drawing of a dog wearing a beanie”) within the text input object 610.

Furthermore, as shown in FIG. 6, upon receiving the content creation request 612 from the client device 602, the custom content generation system 106 utilizes the content creation request 612 and the user account content items 606 with the custom content generation model 616 (e.g., fine-tuned using the user account content items 606 as described above) to generate a new, custom content item 618. As shown in FIG. 6, the new, custom content item 618 portrays one or more features described in the content creation request 612 (e.g., “drawing of a dog wearing a beanie”). In addition, the new, custom content item 618 is stylized by the custom content generation model 616 to utilize (or emulate) one or more attributes corresponding to the user account content items 606 (e.g., a shading style).

As further shown in FIG. 6, the custom content generation system 106 can utilize a custom content generation model with a content creation request and generate a new, custom content item that depicts one or more features described in the content creation request while also emulating attributes from content items associated with multiple user accounts. For instance, the custom content generation system 106 can utilize the content creation request 612, the user account content items 606, and the user account content 614a-614n. with the custom content generation model 616 (e.g., fine-tuned using the user account content items 606 and the user account content 614a-614n as described above) to generate a custom content item that emulates attributes from content items of the multiple user accounts. For example, the resulting custom content item can be stylized by the custom content generation model 616 (trained using the user account content items 606 and the user account content 614a-614n) to include one or more attributes corresponding to the user account content items 606 and the user account content 614a-614n (e.g., a shading style from a first user and a drawing style of a second user).

In some instances, the custom content generation system 106 can utilize content item weights with a custom content generation model to generate custom content items. For example, in some embodiments, the custom content generation system 106 utilizes content item weights to cause the custom content generation model to emphasize (or deemphasize) one or more content items during the generation of a custom content item (in accordance with one or more implementations herein). Furthermore, the custom content generation system 106 can provide selectable options to receive user-selected content item weights.

For instance, as shown in FIG. 6, the custom content generation system 106 can provide, for display within the GUI 604, selectable options 620 to select content item weights for various user account content items 606 associated with the user account. Furthermore, upon receiving user selections (or adjustments) in the selectable options 620 for the content item weights, the custom content generation system 106 can utilize the content item weights 622 with the custom content generation model 616. In particular, the custom content generation system 106 can utilize the content item weights 622 to generate the custom content item 618 to emphasize the one or more attributes of user account content items 606 based on the content item weights 622. As an example, upon receiving a user interaction that increases the content item weight for a first content item and decreases the content item weight for a second content item, the custom content generation system 106 can utilize the custom content generation model with the content item weights to generate a custom content item that emphasizes attributes from the first content item and deemphasizes attributes from the second content item.

Although one or more embodiments herein illustrate the custom content generation system 106 utilizing a custom content generation model to generate a singular digital image (as the custom content item), the custom content generation system 106 can generate a various number of custom content items for a user account. For instance, the custom content generation system 106 can generate, utilizing the custom content generation model, a collection of content items from one or more content creation requests (e.g., “drawings of different dogs wearing beanies” “drawing of a story board of a dog walking,” “draw a dog wearing a beanie in different seasons”). Indeed, the custom content generation system 106 can utilize the custom content generation model to generate multiple custom content items from a content creation request (upon detecting a request to generate multiple content items).

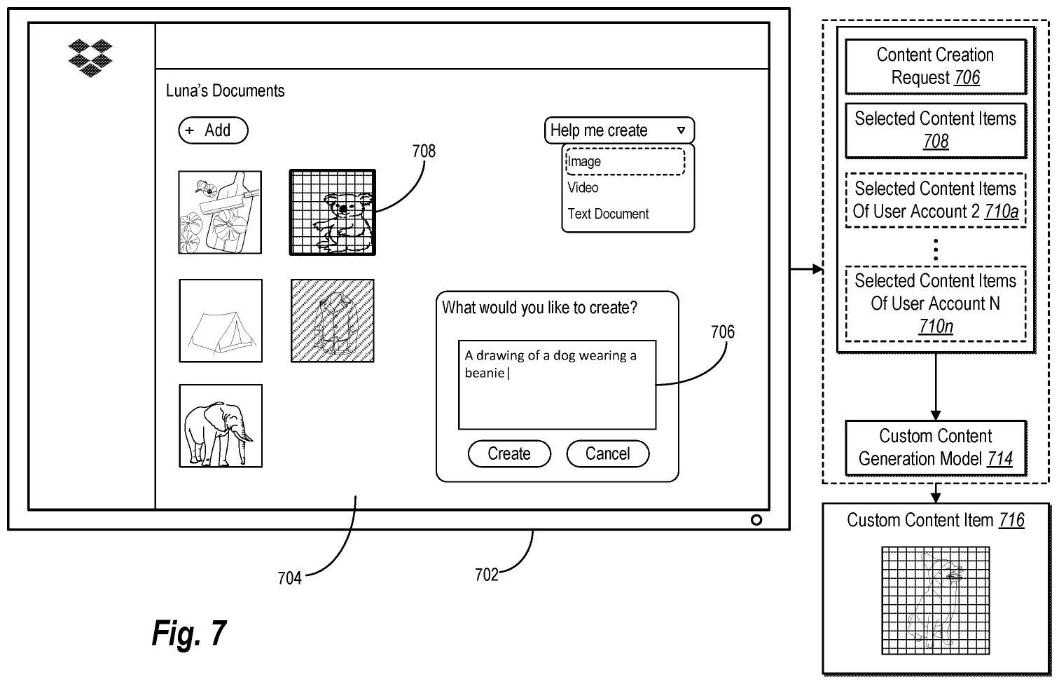

Additionally, as mentioned above, the custom content generation system 106 can generate a custom content generation model that receives a content creation request and generates a new, custom content item that depicts one or more features described in the content creation request while also emulating one or more attributes from user-selected content items in the generated custom content item. For example, FIG. 7 illustrates the custom content generation system 106 utilizing a custom content generation model with user-selected content items 708 to generate a custom content item. In particular, FIG. 7 illustrates the custom content generation system 106 utilizing a custom content generation model that is trained to depict (by synthesizing) one or more features described in a content creation request while also emulating attributes from one or more user-selected content items.

As shown in FIG. 7, the custom content generation system 106 provides, for display within a GUI 704 on a client device 702, a text input object (to receive a content creation request) upon receiving a user interaction with a selectable option to initiate a content creation request. Furthermore, as shown in FIG. 7, the custom content generation system 106 receives a content creation request 706 (e.g., “drawing of a dog wearing a beanie”) within the text input object. Furthermore, as shown in FIG. 7, the custom content generation system 106 receives, within the GUI 704, a user selection of the selected content items 708 (e.g., a subset of content items).

Additionally, as shown in FIG. 7, upon receiving the content creation request 706 from the client device 702, the custom content generation system 106 utilizes the content creation request 706 and the selected content items 708 with the custom content generation model 714 (e.g., fine-tuned using user account content items as described above) to generate a new, custom content item 716. As shown in FIG. 7, the custom content item 716 is stylized by the custom content generation model 714 to utilize (or emulate) one or more attributes corresponding to the user-selected content items 708 (e.g., a grid shading style).

In particular, in one or more embodiments, the custom content generation system 106 can receive a user selection of one or more content items with a content creation request. Subsequently, the custom content generation system 106 can signal to the custom content generation model to generate custom content items utilizing (or providing attention to) attribute (or attribute representations) from the user-selected content items. For instance, in some cases, the custom content generation system 106 can modify weights of content items by providing a weight to the user-selected content items and a null or zero weight to other content items associated with the user account. Moreover, the custom content generation system 106 can utilize the custom content generation model with the user-selected content items to generate a custom content item (e.g., an image) that emulates (or synthesizes) at least one attribute from the user-selected content items.

In some embodiments, the custom content generation system 106 provides, for display within a GUI, selectable options to adjust (or modify) content item weights for the user-selected content items (e.g., subset of content items). For instance, the custom content generation system 106 can display selectable options for content item weights for the user-selected content items as described above (e.g., in relation to FIG. 6). Indeed, the custom content generation system 106 can utilize the user-selected content item weights to emphasize or deemphasize various user-selected content items during generation of a custom content item via the custom content generation model (as described above).

As further shown in FIG. 7, in some cases, the custom content generation system 106 can receive user-selected content items (e.g., a subset of content items) from multiple accounts (e.g., selected content items of user accounts 710a-710n). Indeed, the custom content generation system 106 can utilize a custom content generation model fine-tuned using content items from the multiple accounts (as described above) to generate custom content items that emulate (or synthesize) one or more attributes from the content items associated with the multiple accounts. Upon receiving the user-selected content items from the multiple accounts (e.g., user selections within a shared folder, separate user selections by multiple users), the custom content generation system 106 can utilize a content creation request and the selected content items from the multiple user accounts (e.g., the selected content items 708 and the selected content items of user accounts 710a-710n) with a custom content generation model to generate a new, custom content item that emulates (or synthesizes) at least one attribute from the user-selected content items from the multiple user accounts.

In some embodiments, the custom content generation system 106 can receive a user selection of content items (e.g., a subset of content items) by identifying a user-selected folder of content items. For instance, the custom content generation system 106 can identify a folder of content items to generate custom content items that emulate (or synthesize) one or more attributes from the content items within the user-selected folder. In some cases, the custom content generation system 106 can receive a user selection of content items by enabling a user account to move user-selected content items into a folder specific for the custom content generation model (e.g., drag and drop content items in a working folder for the custom content generation model). Subsequently, the custom content generation system 106 can utilize the custom content generation model with the content items within the folder to generate custom content items that emulate (or synthesize) one or more attributes from the content items within the folder. Additionally, the custom content generation system 106 can utilize a folder that is accessible by multiple user accounts (e.g., a shared folder) with content items associated with multiple user accounts to utilize a custom content generation model fine-tuned using content items from the multiple accounts (as described above) to generate custom content items that emulate (or synthesize) one or more attributes from the content items associated with the multiple accounts via the shared folder.

In some instances, the custom content generation system 106 can receive a user-selected content item and a content creation request to modify the user-selected content item. For instance, the custom content generation system 106 can receive a user selection of a content item that depicts an uncolored object (e.g., an uncolored animal or building) and a content creation request text input indicating “color this image using my coloring style.” In response, the custom content generation system 106 can utilize the custom content generation model to generate a custom content item having one or more features from the content creation request (e.g., “color” and “this image”) using an attribute (e.g., “coloring style” from content items associated with the user account. Indeed, the custom content generation system 106 can utilize the custom content generation model to generate a custom content item that is a colored version of the user-selected content item (mimicking the coloring style detected from other content items of the user account).

As another example, the custom content generation system 106 can receive a user-selected content item and a content creation request to modify the user-selected content item by completing (or filling in) a rudimentary sketch. For instance, the custom content generation system 106 can receive a user-selected content item that depicts a rudimentary sketch of a feature (e.g., a river). Moreover, the custom content generation system 106 can receive a content creation request indicating “fill in this sketch using my painting style.” Indeed, the custom content generation system 106 can utilize the custom content generation model with the user-selected content item that depicts a rudimentary sketch of a feature (e.g., a river) and the particular content creation request to generate a custom content item that depicts a painting of a river using one or more attributes (or style) of content items associated with the user account. In one or more embodiments, the custom content generation system 106 can receive various user-selected content items and various content creation request to modify the user-selected content item with various modifications, such as, but not limited to, color, shading, lighting, mood, geometry, and/or texture.

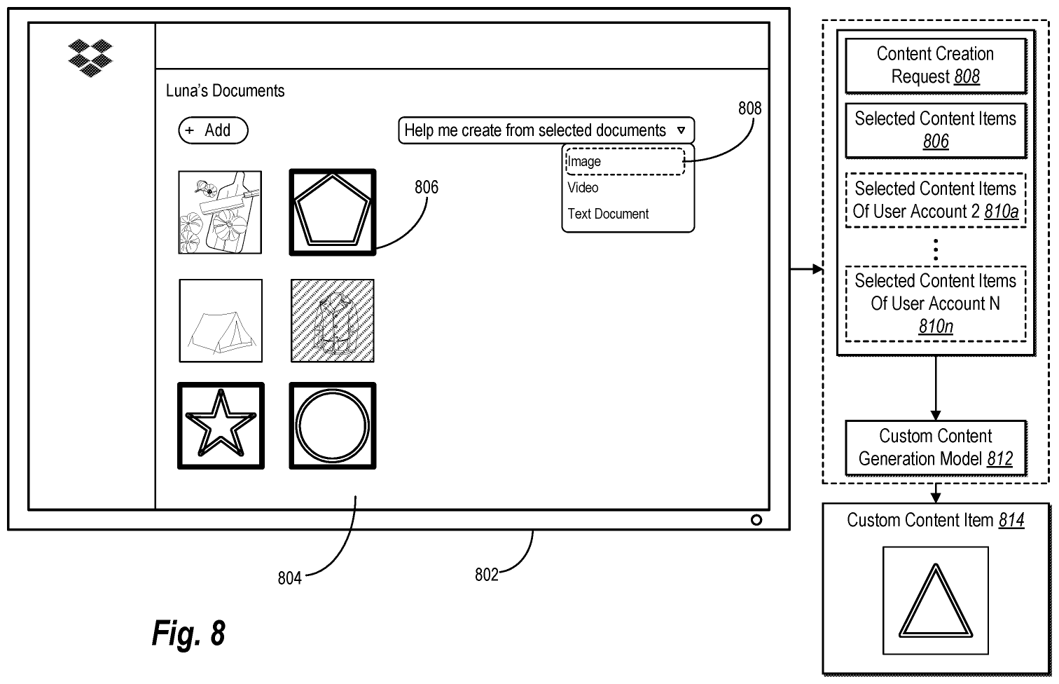

As also mentioned above, the custom content generation system 106 can utilize a custom content generation model with one or more input content items to generate a new, custom content item that depicts a combination of features described in the one or more input content items while also emulating attributes from content items associated with a user account. For example, FIG. 8 illustrates the custom content generation system 106 generating a new, custom content item that depicts a combination of features depicted in the one or more input content items while also emulating attributes from content items associated with a user account. In particular, FIG. 8 illustrates the custom content generation system 106 detecting a user selection of one or more content items and utilizing a custom content generation model to generate a custom content item that depicts a combination of features described in the one or more selected content items while also emulating attributes from content items associated with a user account.

As shown in FIG. 8, the custom content generation system 106 provides, for display within a GUI 804 on a client device 802, a selectable option to initiate a content creation request 808 using selected content items (e.g., a subset of content items). Furthermore, as shown in FIG. 8, the custom content generation system 106 receives a user selection of the selected content items 806. Additionally, as shown in FIG. 8, upon receiving the content creation request 808 and the selected content items 806 from the client device 802, the custom content generation system 106 utilizes the content creation request 808 and the selected content items 806 with the custom content generation model 812 (e.g., fine-tuned using user account content items as described above) to generate a custom content item 814. As shown in FIG. 8, the custom content item 814 depicts a feature similar to the features of the one or more selected content items 806 (e.g., shapes) while also emulating attributes from content items associated with the user account (e.g., double lines).

As shown in FIG. 8, the custom content generation system 106 can utilize the custom content generation model 812 to generate custom content items that depict features similar to features in user-selected content items from the content creation request (e.g., “help me create from the selected documents). For example, the custom content generation system 106 can depict feature similar to features in user-selected content items by, but not limited to, portraying a third animal when the selected content items portray a first and second animal and/or portraying a new shape when the selected content items portray shapes.

In some cases, the custom content generation system 106 mixes and/or combines various features from the user-selected content items utilizing the custom content generation model. For instance, upon receiving a content creation request that request a new content item generated using a combination of a first user-selected input image portraying a car and a second user-selected input image portraying a carpet material, the custom content generation system 106 can utilize the custom content generation model to generate an image that depicts a car made of carpet material (with one or more other attributes from content associated with the user account in accordance with one or more embodiments herein). Indeed, the custom content generation system 106 can combine various features of user-selected content items to generate new, custom content items that combine (or utilize) the various features in various different styles (e.g., having an object wear another object portrayed in the content items, change the material of an object to another material portrayed in another content item).

As further shown in FIG. 8, in some instances, the custom content generation system 106 can receive user-selected content items from multiple accounts (e.g., selected content items of user accounts 810a-810n). Indeed, the custom content generation system 106 can utilize a custom content generation model fine-tuned using content items from the multiple accounts (as described above) to generate custom content items that emulate (or synthesize) one or more attributes from the content items associated with the multiple accounts. Upon receiving the user-selected content items from the multiple accounts (e.g., user selections within a shared folder, separate user selections by multiple users), the custom content generation system 106 can utilize the selected content items from the multiple user accounts (e.g., the selected content items 806 and the selected content items of user accounts 810a-810n) with a custom content generation model to generate a new, custom content item that depict features similar to features in user-selected content items and/or combines (mixes) various features from the user-selected content items (as described above) while emulating (or synthesizing) at least one attribute from the user-selected content items from the multiple user accounts.

Moreover, in some embodiments, the custom content generation system 106 can automatically suggest custom content items to a user account. For instance, the custom content generation system 106 can utilize content items from the user account with the custom content generation model as input content items to generate a new, custom content items that depict a combination of features described in the one or more input content items associated with a user account while also emulating attributes from the content items associated with the user account. Indeed, the custom content generation system 106 can automatically select one or more (or a specific folder) of content items from a user account and utilize the selected content items with the custom content generation model to generate custom content items. Then, the custom content generation system 106 can provide, for display within a GUI, the generated custom content items as suggested (or recommended) content items for the user account (e.g., without a specific user request for the custom content items or in response to a user request for random content items, such as a request indicating “show me some new images”).

Additionally, in one or more embodiments, the custom content generation system 106 utilizes varying weights for attributes represented in content items associated with a user account (e.g., content attribute weights) within a custom content generation model. In particular, the custom content generation system 106 can assign weights to attributes of content items. Subsequently, the custom content generation system 106 can utilize the weights to cause a custom content generation model to emphasize (or deemphasize) one or more attributes from user account content items during the generation of a custom content item (in accordance with one or more implementations herein). Furthermore, in some cases, custom content generation system 106 receives user-selected weights for the content attribute weights.

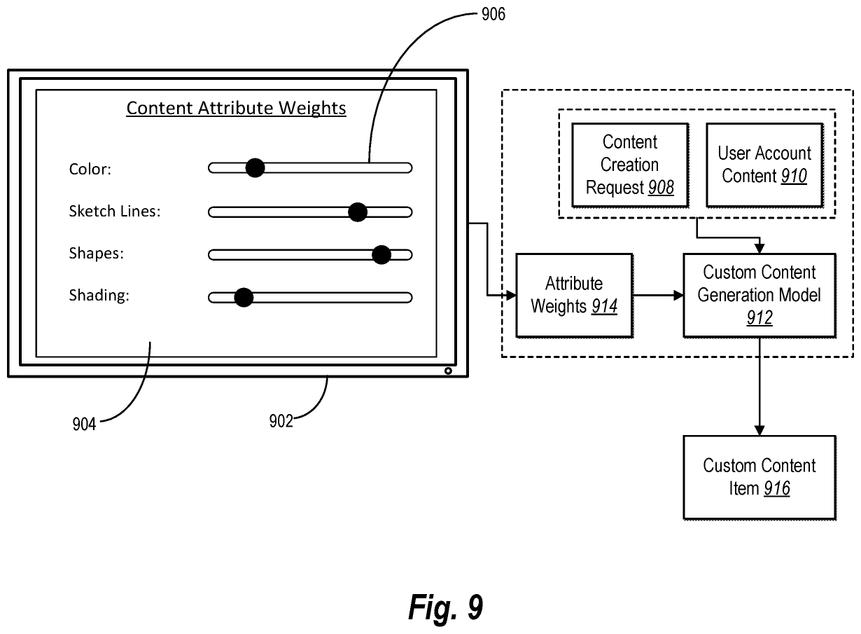

For example, FIG. 9 illustrates the custom content generation system 106 utilizing user-selected content attribute weights for a custom content generation model. As shown in FIG. 9, the custom content generation system 106 provides, for display within a GUI 904 of a client device 902, selectable options 906 to select content attribute weights for various attributes of content items. For instance, as shown in FIG. 9, the custom content generation system 106 provides selectable content attribute weights for attributes, such as, color, sketch lines, shape, and shading from the content items associated with the user account.

Furthermore, upon receiving user selections (or adjustments) in the selectable options 906 for the content attribute weights, the custom content generation system 106 utilizes the attribute weights 914 with the custom content generation model 912. In particular, as shown in FIG. 9, the custom content generation system 106 utilizes a content creation request 908 with the custom content generation model 912 (which is fine-tuned to synthesize one or more attributes from user account content item 910) to generate a custom content item 916 that depicts one or more features from the content creation request 908 while also emulating (or synthesizing) one or more attributes from the user account content item 910 (as described above). Moreover, the custom content generation system 106 utilizes the attribute weights 914 (e.g., during fine-tuning of the custom content generation model 912 and/or during the generation of the custom content item 916) to emphasize (or deemphasize) one or more attributes from user account content item 910 in the custom content item 916.

As an example, upon receiving a user interaction that increases the content attribute weight for the attribute of color and decreases the content attribute weight for the attribute shading, the custom content generation system 106 can utilize the custom content generation model with the attribute weights to generate a custom content item by synthesizing colors from the user account content items (e.g., more emphasis) while placing less of an emphasis on synthesizing the shading from the user account content items in the custom content item. As another example, upon receiving a user interaction that decreases the content attribute weight for the attribute of lighting and increases the content attribute weight for the attribute of shapes, the custom content generation system 106 can utilize the custom content generation model with the attribute weights to generate a custom content item by synthesizing lighting from the user account content items with less emphasis and while synthesizing shapes from the user account content items with a greater emphasis.

In some instances, the custom content generation system 106 utilizes the user-selected content attribute weights to fine tune parameters of a custom content generation model. For instance, the custom content generation system 106 can utilize the user-selected content attribute weight selections to modify parameters of the custom content generation model that control attributes in generated outputs of the custom content generation model while training the custom content generation model to emulate one or more attributes of one or more content items associated with a user account (or multiple user accounts) (as described above). Indeed, the custom content generation system 106 can modify the parameters of the custom content generation model to cause the custom content generation model to emulate one or more attributes of one or more content items associated with a user account (or multiple user accounts) according to the user-selected content attribute weights.

Furthermore, in one or more embodiments, the custom content generation system 106 can identify one or more attributes from content items associated with a user account for content attribute weight selectors. In particular, the custom content generation system 106 can identify one or more content attributes from the content items associated with the user account that are more prevalent in the content items (e.g., attributes that are present or occur over a threshold number of times, attributes that are present or occur in a proportion that satisfies a threshold proportion). Then, the custom content generation system 106 can provide, for display in a GUI, content attribute weight selectors for the identified content attributes.

Moreover, in one or more embodiments, the custom content generation system 106 utilizes varying weights for request features represented in content creation requests within a custom content generation model. For instance, the custom content generation system 106 can assign weights to specific features described in a content creation request. Moreover, the custom content generation system 106 can utilize the weights to cause a custom content generation model to emphasize (or deemphasize) one or more features from the content creation request during the generation of a custom content item (in accordance with one or more implementations herein). Furthermore, in some cases, custom content generation system 106 receives user-selected weights for the request feature weights.

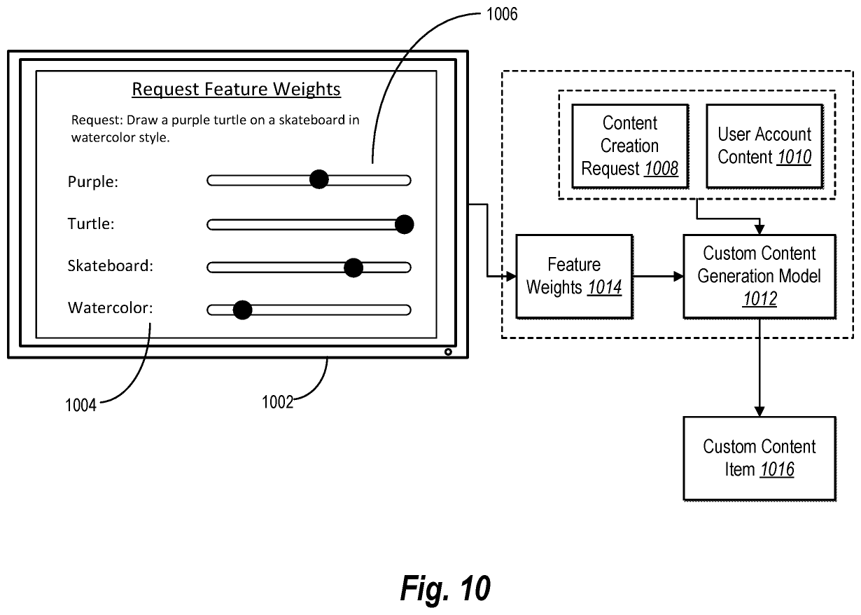

For example, FIG. 10 illustrates the custom content generation system 106 utilizing user-selected request feature weights for a custom content generation model. As shown in FIG. 10, the custom content generation system 106 provides, for display within a GUI 1004 of a client device 1002, selectable options 1006 to select request feature weights for various features identified from a content creation request 1008. For instance, as shown in FIG. 10, the custom content generation system 106 provides selectable request feature weights for features, such as, “purple,” “turtle,” “skateboard,” and “watercolor” from the features described in the content creation request 1008 (e.g., “draw a purple turtle on a skateboard in watercolor style”).

In addition, upon receiving user selections (or adjustments) in the selectable options 1006 for the request feature weights, the custom content generation system 106 utilizes the feature weights 1014 with the custom content generation model 1012. In particular, as shown in FIG. 10, the custom content generation system 106 utilizes the content creation request 1008 with the custom content generation model 1012 (which is fine-tuned to synthesize one or more attributes from user account content 1010) to generate a custom content item 1016 that depicts one or more features from the content creation request 1008 according to the feature weights 1014 while also emulating (or synthesizing) one or more attributes from the user account content 1010 (as described above). Indeed, the custom content generation system 106 utilizes the feature weights 1014 (e.g., during fine-tuning of the custom content generation model 1012 and/or during the generation of the custom content item 1016) to emphasize (or deemphasize) one or more features from content creation request 1008 in the custom content item 1016.

As an example, upon receiving a user interaction that increases the content attribute weight for the feature “turtle” and decreases the content attribute weight for the feature “watercolor”, the custom content generation system 106 can utilize the custom content generation model with the feature weights to generate a custom content item emphasizing a depiction of a turtle in the custom content item while deemphasizing the watercolor feature within the custom content item. As another example, upon receiving a user interaction that decreases the feature weight for the feature of turtle and increases the feature weight for the feature of skateboard, the custom content generation system 106 can utilize the custom content generation model with the feature weights to generate a custom content item that emphasizes the depiction of a skateboard while reducing the emphasis (or presence) of the depiction of a turtle in the custom content item.

Furthermore, in one or more embodiments, the custom content generation system 106 can identify one or more features from a content creation request associated with a user account for request feature weight selectors. In particular, the custom content generation system 106 can identify (e.g., using word or term recognition approaches) one or more features from the content creation request that are more prevalent in the content creation request (e.g., features that are present or occur over a threshold number of times, features that are present or occur in a proportion that satisfies a threshold proportion). Then, the custom content generation system 106 can provide, for display in a GUI, request feature weight selectors for the identified features.

Additionally, in some instances, the custom content generation system 106 can generate a custom content item 1016 utilizing the custom content generation model 1012 based on the content creation request 1008 (in accordance with one or more embodiments) and subsequently generate an updated custom content item after receiving request feature weights. For instance, the custom content generation system 106 can generate the custom content item 1016 and provide, for display within a GUI, a preview of the custom content item 1016. In addition, the custom content generation system 106 can provide, for display within the GUI, one or more feature weight selectors for features in the content creation request 1008 with the preview of the custom content item 1016. Upon receiving modifications to the feature weights within the one or more feature weight selectors for features in the content creation request 1008, the custom content generation system 106 can generate an updated custom content item by utilizing the custom content generation model 1012 with the modified feature weights (in accordance with one or more embodiments herein).

Moreover, although one or more embodiments herein illustrate the custom content generation system 106 utilizing slider elements for weight selectors, the custom content generation system 106 can utilize various user interface elements for the weight selectors (e.g., content attribute weights, request feature weights, content item weights (as shown in FIG. 6)). For example, the custom content generation system 106 can provide, for display within a GUI, a numerical input field (e.g., a text box) to receive user-selected weights for the content attribute weights, request feature weights, and/or content item weights (as shown in FIG. 6). In some cases, the custom content generation system 106 can provide, for display within a GUI, radio selectors (or dial selectors) for various weight values to receive user-selected weights for the content attribute weights, request feature weights, and/or content item weights (as shown in FIG. 6).

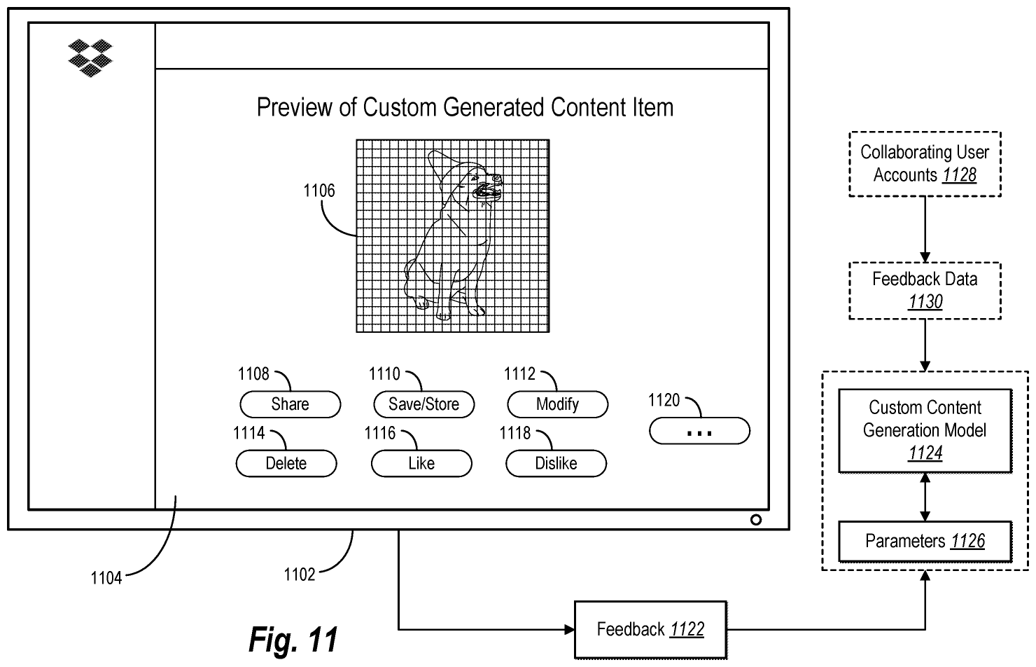

As mentioned above, the custom content generation system 106 can enable various functionalities for a user account with respect to the generated custom content item. For instance, FIG. 11 illustrates the custom content generation system 106 providing various functionalities for the custom content item within a GUI. Indeed, as shown in FIG. 11, the custom content generation system 106 provides, for display within a GUI 1104 of a client device 1102, a preview of a custom content item 1106 (generated in accordance with one or more implementations herein). Furthermore, as shown in FIG. 11, the custom content generation system 106 provides, for display within the GUI 1104, various selectable options for the custom content item 1106 (e.g., to share the custom content item, store the custom content item, modify the custom content item, to provide feedback for the custom content item).

For example, as shown in FIG. 11, the custom content generation system 106 provides, for display within the GUI 1104, a selectable option 1108 for sharing the custom content item 1106. In particular, upon receiving a user interaction with the selectable option 1108, the custom content generation system 106 can enable a user account to share the custom content item 1106. For instance, the custom content generation system 106 can enable the user account to share the custom content item 1106 to other user accounts within the content management system 104, through e-mail, through instant messaging, and various other communication mediums.

Furthermore, as shown in FIG. 11, the custom content generation system 106 provides, for display within the GUI 1104, a selectable option 1110 for saving the custom content item 1106. For instance, upon receiving a user interaction with the selectable option 1110, the custom content generation system 106 can enable a user account to save and/or store the custom content item 1106. In some embodiments, the custom content generation system 106 enables the user account to save (or store) the custom content item 1106 within a repository of the content management system 104 that is accessible by the user account (e.g., a cloud data storage service account) or by multiple user accounts (e.g., a shared folder). In some instances, the custom content generation system 106 can enable the user account to store the custom content item 1106 within a folder (or shared folder) accessible by multiple user accounts within the content management system 104. Furthermore, the custom content generation system 106 can also enable the user account to download the custom content item 1106 within a client device corresponding to the user account

As shown in FIG. 11, the custom content generation system 106 provides, for display within the GUI 1104, a selectable option 1112 for modifying the custom content item 1106. For instance, in response to receiving a user selection of the selectable option 1112, the custom content generation system 106 can initiate a content modification application (e.g., an image modification application, a video modification application) that enables user modifications to the custom content item 1106. For example, the custom content generation system 106 can enable a user account to modify the custom content item 1106 via modification to attributes or features of the custom content item 1106. To illustrate, the custom content generation system 106 can enable modification of attributes and features via functionalities, such as, but not limited to, modifications to color, modifications to saturation, modifications to lighting (e.g., brightness, contrast, exposure), modifications to sizing (e.g., aspect ratio, cropping), and/or modifications to content (e.g., adding content or removing content from the custom content item 1106).

Additionally, as shown in FIG. 11, the custom content generation system 106 provides, for display within the GUI 1104, a selectable option 1114 for deleting the custom content item 1106. For instance, in response to receiving a user interaction with the selectable option 1114, the custom content generation system 106 can delete (or remove) the custom content item 1106. In particular, the custom content generation system 106 can delete the custom content item 1106 from storage allocated to the user account within the content management system 104.

Moreover, as shown in FIG. 11, the custom content generation system 106 provides, for display within the GUI 1104, a selectable option 1116 and a selectable option 1118 for providing feedback on the custom content item 1106 (e.g., options for liking or disliking the custom content item 1106). In particular, the custom content generation system 106 can receive a user interaction with the selectable option 1116 and identify the interaction as an indication that a user of the user account approved of (or liked) the custom content item 1106. Additionally, the custom content generation system 106 can receive a user interaction with the selectable option 1118 and identify the interaction as an indication that a user of the user account disapproved of (or disliked) the custom content item 1106.

Moreover, as shown in FIG. 11, the custom content generation system 106 can provide, for display within the GUI 1104, a selectable option 1120 for various other functionalities for the custom content item 1106. Indeed, upon receiving a selection of the selectable option 1120, the custom content generation system 106 can provide, for display within the GUI 1104, various additional options corresponding to the custom content item 1106. For instance, the custom content generation system 106 can provide, for display within the GUI 1104, selectable options for functionalities, such as, but not limited to, downloading the custom content item 1106, flagging the custom content item 1106, uploading the custom content item 1106 to a marketplace or digital store, and/or accessing information on the custom content item 1106.

Furthermore, in some cases (as shown in FIG. 11), the custom content generation system 106 utilizes one or more of the user interactions with the one or more selectable function options (described above) as feedback for the custom content generation model. For example, as shown in FIG. 11, the custom content generation system 106 can utilize the user interaction within the GUI 1104 as feedback 1122 to modify parameters 1126 of the custom content generation model 1124. As further shown in FIG. 11, the custom content generation system 106 can also utilize feedback data 1130 from collaborating user accounts 1128. Indeed, the custom content generation system 106 can store feedback provided from user interactions within a custom content generation model to utilize the feedback in training (or further customizing) the custom content generation model to create a user-specific custom content generation model that reflects preferences of a particular user (or particular users). Indeed, the custom content generation system 106 can generate an updated custom content generation model based on fine-tuning the custom content generation model using the feedback. In some cases, the custom content generation system 106 can further store the updated content generation model in a custom content generation model versioning repository (as described above).

As an example, the custom content generation system 106 can receive a user interaction with a positive feedback function. To illustrate, the custom content generation system 106 can receive a user interaction with a positive feedback function, such as, but not limited to, sharing the custom content item, liking the custom content item, saving the custom content item, modifying the custom content item to share the custom content item. Indeed, the custom content generation system 106 can utilize the positive feedback interaction to confirm to the custom content generation model 1124 that the parameters 1126 are accurate (or improving).

As another example, the custom content generation system 106 can receive a user interaction with a negative feedback function. To illustrate, the custom content generation system 106 can receive a user interaction with a negative feedback function, such as, but not limited to, deleting, disliking, or modifying the custom content item to fix an attribute of the custom content item. Indeed, the custom content generation system 106 can utilize the negative feedback interaction to modify the parameters 1126 to improve the accuracy of the custom content generation model 1124 (e.g., in iterative requests).

In some embodiments, the custom content generation system 106 can provide, for display, multiple custom content items generated by the custom content generation model in a preview. Furthermore, the custom content generation system 106 can enable a user account to interact with the multiple custom content items. For instance, in some cases, the custom content generation system 106 can utilize one or more of the functionalities described above with the multiple custom content items. In some implementations, the custom content generation system 106 can provide a selectable option to indicate one or more preferred custom content items (e.g., an option to indicate “more like this image”) from the multiple custom content items. Indeed, the custom content generation system 106 can utilize the selected preferred custom content items as input for the custom content generation model (to weight or emphasize) features and/or attributes of the selected preferred custom content items in subsequent custom content item creations from the custom content generation model.

In some cases, the custom content generation system 106 utilizes the selected preferred custom content items as seed content for the custom content generation model. In particular, the custom content generation system 106 can identify or determine variances of a custom content item to add randomness to the custom content item to generate additional custom content items that are similar in features and attributes to the custom content item. Indeed, the custom content generation system 106 can utilize selected custom content items (as the user-selected content items described in FIG. 7) to cause the custom content generation model to emulate attributes of the selected custom content items in subsequent generated custom content items.

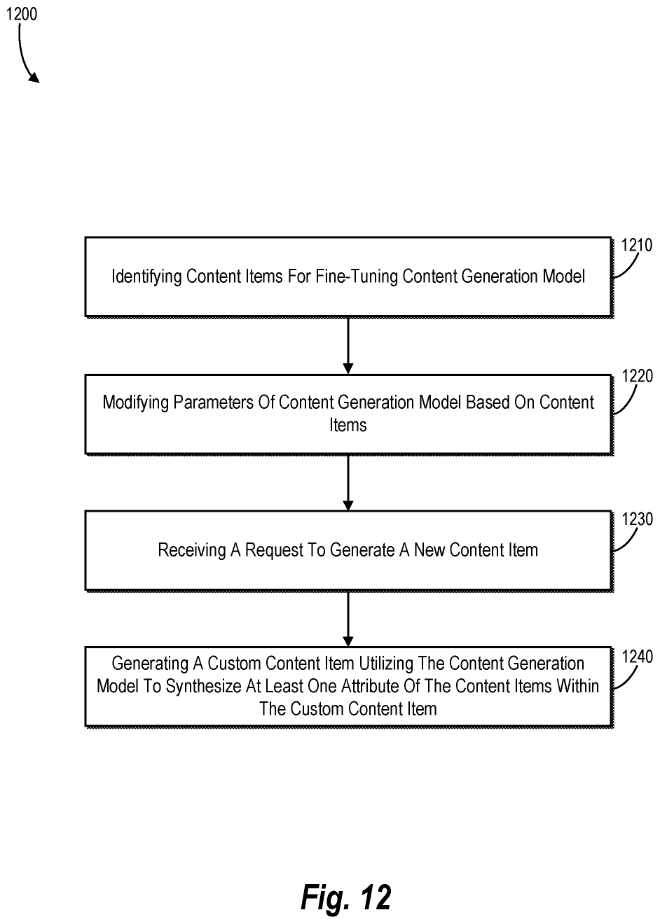

FIGS. 1-11, the corresponding text, and the examples provide a number of different methods, systems, devices, and non-transitory computer-readable media of the custom content generation system 106. In addition to the foregoing, one or more implementations can also be described in terms of flowcharts comprising acts for accomplishing a particular result, as shown in FIG. 12. The acts shown in FIG. 12 may be performed in connection with more or fewer acts. Further, the acts may be performed in differing orders. Additionally, the acts described herein may be repeated or performed in parallel with one another or parallel with different instances of the same or similar acts. A non-transitory computer-readable medium can comprise instructions that, when executed by one or more processors, cause a computing device to perform the acts of FIG. 12. In some implementations, a system can be configured to perform the acts of FIG. 12. Alternatively, the acts of FIG. 12 can be performed as part of a computer-implemented method.

FIG. 12 illustrates a flowchart of a series of acts 1200 for utilizing machine learning to intelligently generate new, custom content items that emulate user-specific content attributes based on content collections associated with a user account in accordance with one or more implementations. While FIG. 12 illustrates acts according to one implementation, alternative implementations may omit, add to, reorder, and/or modify any of the acts shown in FIG. 12.

As shown in FIG. 12, the series of acts 1200 include an act 1210 of identifying content items for fine-tuning content generation model. For instance, the act 1210 can include identifying, for a user account of a content management system, one or more content items associated with a user account. Furthermore, the act 1210 can include identifying, for a user account of a content management system, one or more (or a set of) content items for fine-tuning parameters of a content generation model trained to generate new content items. In some embodiments, the act 1210 can include receiving, from a client device associated with a user account, a selection of user-selected content items from one or more content items.

Furthermore, the act 1210 can include identifying, from an additional user account of a content management system, one or more additional content items associated with the additional user account. In certain instances, the act 1210 includes identifying, from an additional user account of a content management system, one or more additional content items for fine-tuning parameters of a content generation model trained to generate new content items.

As further shown in FIG. 12, the series of acts 1200 include an act 1220 of modifying parameters of content generation model based on the content items. For example, the act 1220 can include modifying parameters of a content generation model based on at least one attribute associated with one or more content items (associated with a user account). Additionally, the act 1220 can include modifying parameters of a content generation model based on at least one attribute associated with one or more content items (associated with a user account) and at least one additional attribute associated with the one or more additional content items (associated with an additional user account).

As shown in FIG. 12, the series of acts 1200 include an act 1230 of receiving a request to generate a new content item. For example, the act 1230 can include receiving, from a client device associated with a user account, a request to generate a new content item (based on one or more content items associated with a user account). For example, the act 1230 can include receiving a request to generate a new content item by receiving a text prompt describing content (or one or more features) to depict within a new content item. In one or more embodiments, the act 1230 can include receiving one or more user-selected menu options including one or more features to depict within a new content item as a content description (of a request to generate a new content item). In some cases, the act 1230 includes receiving, from a client device associated with a user account, a request to generate a new content item based on a content description corresponding to the request (and/or based on one or more content items). Additionally, the act 1230 can include receiving, from a client device associated with a user account, a request to generate a new content item based on a user selection of a subset of content items from a set of content items.

In some cases, the act 1230 can include receiving, from a client device associated with a user account, an attribute weight for at least one attribute. Furthermore, the act 1230 can include identifying one or more feature weights associated with one or more features of a content description (from a request to generate a new content item). In addition, the act 1230 can include receiving, from a client device associated with a user account, one or more content item weights for a subset of content items.

As further shown in FIG. 12, the series of acts 1200 include an act 1240 of generating a custom content item utilizing the content generation model to synthesize at least one attribute of the content items within the custom content item. For example, the act 1240 can include, in response to a request to generate a new content item, generating a custom content item utilizing a content generation model to synthesize at least one attribute associated with one or more content items within the custom content item. In some cases, the act 1240 can include generating a custom content item by utilizing a content generation model to synthesize one or more features represented in content of a text prompt. In some instances, the act 1240 can include, in response to a request to generate a new content item and a user selection of a subset of content items, generate a custom content item utilizing a content generation model to synthesize at least one attribute associated with the subset of content items within the custom content item.

In some embodiments, the act 1240 can include, in response to a request to generate a new content item, generating a custom content item utilizing a content generation model to synthesize at least one attribute associated with user-selected content items within the custom content item. In some instances, the act 1240 can include, in response to a request to generate a new content item, generating a custom content item by utilizing a content generation model to synthesize content that depicts a content description from a request with at least one attribute from one or more content items (associated with a user account) within the custom content item. Additionally, the act 1240 can include generating a custom content item utilizing a content generation model to synthesize at least one attribute associated with one or more content items (from a user account) and at least one additional attribute associated with one or more additional content items (from an additional user account) within the custom content item. For example, a custom content item can include an image, a video, or a text document. Furthermore, an attribute can include a visual characteristic.

In one or more implementations, the act 1240 includes generating a custom content item by utilizing a content generation model to synthesize at least one attribute associated with one or more content items within a custom content item based on an attribute weight. Furthermore, the act 1240 can include generating a custom content item by utilizing a content generation model to synthesize content that depicts a content description from a request based on one or more feature weights. In some cases, the act 1240 can include generating a custom content item by utilizing a content generation model to synthesize at least one attribute associated with a subset of content items within the custom content item based on one or more content item weights. Furthermore, the act 1240 can include receiving, from a client device associated with a user account, user feedback for a custom content item and modifying parameters of a content generation model based on a set of content items utilizing the user feedback to generate an updated content generation model.

In some embodiments, the act 1240 includes providing, for display within a graphical user interface of a client device, a custom content item and one or more selectable options to share the custom content item, store the custom content item, or modify the custom content item. In one or more instances, the act 1240 can include providing access to a custom content item to a user account and an additional user account. In addition, the act 1240 can include generating a version history for a content generation model by storing, for a user account of a content management system, a content generation model and an updated content generation model.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 13 illustrates a block diagram of exemplary computing device 1300 that may be configured to perform one or more of the processes described above. One will appreciate that server device(s) 102 and/or the client device 110 may comprise one or more computing devices, such as computing device 1300. As shown by FIG. 13, computing device 1300 can comprise processor 1302, memory 1304, storage device 1306, I/O interface 1308, and communication interface 1310, which may be communicatively coupled by way of communication infrastructure 1312. While an exemplary computing device 1300 is shown in FIG. 13, the components illustrated in FIG. 13 are not intended to be limiting. Additional or alternative components may be used in other embodiments. Furthermore, in certain embodiments, computing device 1300 can include fewer components than those shown in FIG. 13. Components of computing device 1300 shown in FIG. 13 will now be described in additional detail.

In particular embodiments, processor 1302 includes hardware for executing instructions, such as those making up a computer program. As an example and not by way of limitation, to execute instructions, processor 1302 may retrieve (or fetch) the instructions from an internal register, an internal cache, memory 1304, or storage device 1306 and decode and execute them. In particular embodiments, processor 1302 may include one or more internal caches for data, instructions, or addresses. As an example and not by way of limitation, processor 1302 may include one or more instruction caches, one or more data caches, and one or more translation lookaside buffers (TLBs). Instructions in the instruction caches may be copies of instructions in memory 1304 or storage device 1306.

Memory 1304 may be used for storing data, metadata, and programs for execution by the processor(s). Memory 1304 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1304 may be internal or distributed memory.

Storage device 1306 includes storage for storing data or instructions. As an example and not by way of limitation, storage device 1306 can comprise a non-transitory storage medium described above. Storage device 1306 may include a hard disk drive (HDD), a floppy disk drive, flash memory, an optical disc, a magneto-optical disc, magnetic tape, or a Universal Serial Bus (USB) drive or a combination of two or more of these. Storage device 1306 may include removable or non-removable (or fixed) media, where appropriate. Storage device 1306 may be internal or external to computing device 1300. In particular embodiments, storage device 1306 is non-volatile, solid-state memory. In other embodiments, Storage device 1306 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1308 allows a user to provide input to, receive output from, and otherwise transfer data to and receive data from computing device 1300. I/O interface 1308 may include a mouse, a keypad or a keyboard, a touch screen, a camera, an optical scanner, network interface, modem, other known I/O devices or a combination of such I/O interfaces. I/O interface 1308 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interface 1308 is configured to provide graphical data to a display for presentation to a user. The graphical data may be representative of one or more graphical user interfaces and/or any other graphical content as may serve a particular implementation.

Communication interface 1310 can include hardware, software, or both. In any event, communication interface 1310 can provide one or more interfaces for communication (such as, for example, packet-based communication) between computing device 1300 and one or more other computing devices or networks. As an example and not by way of limitation, communication interface 1310 may include a network interface controller (NIC) or network adapter for communicating with an Ethernet or other wire-based network or a wireless NIC (WNIC) or wireless adapter for communicating with a wireless network, such as a WI-FI.

Additionally, or alternatively, communication interface 1310 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1310 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1310 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1312 may include hardware, software, or both that couples components of computing device 1300 to each other. As an example and not by way of limitation, communication infrastructure 1312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 14 is a schematic diagram illustrating environment 1400 within which one or more embodiments of content management system 104 can be implemented. Content management system 1402 may generate, store, manage, receive, and send digital content (such as digital images and videos). For example, content management system 1402 may send and receive digital content to and from client devices 1406 by way of network 1404. In particular, content management system 1402 can store and manage a collection of digital content. Content management system 1402 can manage the sharing of digital content between computing devices associated with a plurality of users. For instance, content management system 1402 can facilitate a user sharing a digital content with another user of content management system 1402.

In particular, content management system 1402 can manage synchronizing digital content across multiple client devices 1406 associated with one or more users. For example, a user may edit digital content using client device 1406. The content management system 1402 can cause client device 1406 to send the edited digital content to content management system 1402. Content management system 1402 then synchronizes the edited digital content on one or more additional computing devices.

In addition to synchronizing digital content across multiple devices, one or more embodiments of content management system 1402 can provide an efficient storage option for users that have large collections of digital content. For example, content management system 1402 can store a collection of digital content on content management system 1402, while the client device 1406 only stores reduced-sized versions of the digital content. A user can navigate and browse the reduced-sized versions (e.g., a thumbnail of a digital image) of the digital content on client device 1406. In particular, one way in which a user can experience digital content is to browse the reduced-sized versions of the digital content on client device 1406.

Another way in which a user can experience digital content is to select a reduced-size version of digital content to request the full- or high-resolution version of digital content from content management system 1402. In particular, upon a user selecting a reduced-sized version of digital content, client device 1406 sends a request to content management system 1402 requesting the digital content associated with the reduced-sized version of the digital content. Content management system 1402 can respond to the request by sending the digital content to client device 1406. Client device 1406, upon receiving the digital content, can then present the digital content to the user. In this way, a user can have access to large collections of digital content while minimizing the number of resources used on client device 1406.

Client device 1406 may be a desktop computer, a laptop computer, a tablet computer, a personal digital assistant (PDA), an in- or out-of-car navigation system, a handheld device, a smart phone or other cellular or mobile phone, or a mobile gaming device, other mobile device, or other suitable computing devices. Client device 1406 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox for iPhone or iPad, Dropbox for Android, etc.), to access and view content over network 1404.

Network 1404 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1406 may access content management system 1402.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
identifying, for a user account of a content management system, one or more content items for fine-tuning parameters of a content generation model trained to generate new content items;
modifying the parameters of the content generation model based on at least one attribute associated with the one or more content items;
receiving, from a client device associated with the user account, a request to generate a new content item; and
in response to the request to generate the new content item, generating a custom content item utilizing the content generation model to synthesize the at least one attribute associated with the one or more content items within the custom content item.

2. The computer-implemented method of claim 1, wherein receiving the request to generate the new content item comprises receiving a text prompt describing content to depict within the new content item.

3. The computer-implemented method of claim 2, wherein generating the custom content item comprises utilizing the content generation model to synthesize one or more features represented in the content of the text prompt.

4. The computer-implemented method of claim 1, further comprising providing, for display within a graphical user interface of the client device, the custom content item and one or more selectable options to share the custom content item, store the custom content item, or modify the custom content item.

5. The computer-implemented method of claim 1, further comprising:
receiving, from the client device associated with the user account, a selection of user-selected content items from the one or more content items; and
in response to the request to generate the new content item, generating the custom content item utilizing the content generation model to synthesize the at least one attribute associated with the user-selected content items within the custom content item.

6. The computer-implemented method of claim 1, further comprising:
identifying, from an additional user account of the content management system, one or more additional content items for fine-tuning the parameters of the content generation model trained to generate the new content items;
modifying the parameters of the content generation model based on the at least one attribute associated with the one or more content items and at least one additional attribute associated with the one or more additional content items; and
generating the custom content item utilizing the content generation model to synthesize the at least one attribute associated with the one or more content items and the at least one additional attribute associated with the one or more additional content items within the custom content item.

7. The computer-implemented method of claim 6, further comprising providing access to the custom content item to the user account and the additional user account.

8. The computer-implemented method of claim 1, further comprising:
receiving, from the client device associated with the user account, an attribute weight for the at least one attribute; and
generating the custom content item by utilizing the content generation model to synthesize the at least one attribute associated with the one or more content items within the custom content item based on the attribute weight.

9. The computer-implemented method of claim 1, wherein the custom content item comprises an image, a video, or a text document.

10. The computer-implemented method of claim 1, wherein the at least one attribute comprises a visual characteristic.

11. A non-transitory computer-readable medium storing instructions that, when executed by at least one processor, cause a computing device to:
identify, for a user account of a content management system, one or more content items associated with the user account;
receive, from a client device associated with the user account, a request to generate a new content item based on a content description corresponding to the request; and
in response to the request to generate the new content item, generate a custom content item by utilizing a content generation model to synthesize content that depicts the content description from the request with at least one attribute from the one or more content items within the custom content item.

12. The non-transitory computer-readable medium of claim 11, wherein the request comprises:
a text prompt comprising one or more features to depict within the new content item as the content description; or
one or more user-selected menu options comprising the one or more features to depict within the new content item as the content description.

13. The non-transitory computer-readable medium of claim 12, further comprising instructions that, when executed by the at least one processor, cause the computing device to:
identify one or more feature weights associated with the one or more features of the content description; and
generate the custom content item by utilizing the content generation model to synthesize the content that depicts the content description from the request based on the one or more feature weights.

14. The non-transitory computer-readable medium of claim 11, further comprising instructions that, when executed by the at least one processor, cause the computing device to:
receive, from the client device associated with the user account, a selection of user-selected content items from the one or more content items; and
generate the custom content item utilizing the content generation model to synthesize the at least one attribute associated with the user-selected content items within the custom content item.

15. The non-transitory computer-readable medium of claim 11, further comprising instructions that, when executed by the at least one processor, cause the computing device to:
identify, from an additional user account of the content management system, one or more additional content items associated with the additional user account;
modify parameters of a content generation model based on the at least one attribute associated with the one or more content items and at least one additional attribute associated with the one or more additional content items;
generate the custom content item utilizing the content generation model to synthesize the content that depicts the content description from the request with the at least one attribute associated with the one or more content items and the at least one additional attribute associated with the one or more additional content items within the custom content item; and
provide access to the custom content item to the user account and the additional user account.

16. A system comprising:
at least one processor; and
at least one non-transitory computer-readable storage medium storing instructions that, when executed by the at least one processor, cause the system to:
identify, for a user account of a content management system, a set of content items for fine-tuning parameters of a content generation model trained to generate new content items;
modify the parameters of the content generation model based on the set of content items;
receive, from a client device associated with the user account, a request to generate a new content item based on a user selection of a subset of content items from the set of content items; and
in response to the request to generate the new content item and the user selection of the subset of content items, generate a custom content item utilizing the content generation model to synthesize at least one attribute associated with the subset of content items within the custom content item.

17. The system of claim 16, wherein receiving the request to generate the new content item comprises receiving a text prompt describing content to depict within the new content item and further comprising instructions that, when executed by the at least one processor, cause the system to generate the custom content item utilizing the content generation model to synthesize one or more features represented in the content of the text prompt.

18. The system of claim 16, further comprising instructions that, when executed by the at least one processor, cause the system to:
receive, from the client device associated with the user account, one or more content item weights for the subset of content items; and
generate the custom content item by utilizing the content generation model to synthesize the at least one attribute associated with the subset of content items within the custom content item based on the one or more content item weights.

19. The system of claim 16, further comprising instructions that, when executed by the at least one processor, cause the system to:
receive, from the client device associated with the user account, user feedback for the custom content item; and
modify the parameters of the content generation model based on the set of content items utilizing the user feedback to generate an updated content generation model.

20. The system of claim 19, further comprising instructions that, when executed by the at least one processor, cause the system to generate a version history for the content generation model by storing, for the user account of the content management system, the content generation model and the updated content generation model.
